(19) United States
(12) Patent Application Publication
(10) Pub. No.: US 2015/0103023 A1
(43) Pub. Date: Apr. 16, 2015

(54) DATA-PROCESSING DEVICE

(71) Applicant: Semiconductor Energy Laboratory Co., Ltd., Atsugi-shi (JP)

(72) Inventor: Yuji IWAKI, Isehara (JP)

(73) Assignee: Semiconductor Energy Laboratory Co., Ltd.

(21) Appl. No.: 14/507,199

(22) Filed: Oct. 6, 2014

(30) Foreign Application Priority Data
Oct. 11, 2013 (JP) 2013-213378

(51) Int. Cl. G06F 3/041

(52) U.S. Cl. CPC G06F 3/0414
USPC 345/173

(57) ABSTRACT

Provided is a data-processing device which includes a flexible position-input portion capable of sensing proximity or touch of an object such as a user's palm and fingers. The data-processing device is arranged so that, in accordance with the position of the user's palm and fingers holding the data-processing device, an image for operation is displayed in a location which is accessible by the fingers.

### BACKGROUND OF THE INVENTION

1. Field of the Invention

The present invention relates to a method and a program for processing and displaying image data, and a device including a storage medium in which the program is stored. The present invention relates to, for example, a method for processing and displaying image data by which an image including data processed by a data-processing device provided with a display portion is displayed, a program for displaying an image including data processed by a data-processing device provided with a display portion, and a data-processing device including a storage medium in which the program is stored.

2. Description of the Related Art

Display devices with large screens can display many pieces of information. Therefore, such display devices are excellent in browsability and suitable for data-processing devices.

The social infrastructures for transmitting information have advanced. This has made it possible to acquire, process, and transmit a wide variety of information with the use of a data-processing device not only at home or office but also away from home or office.

With this situation, portable data-processing devices are under active development.

Because portable data-processing devices are often used outdoors, force might be accidentally applied by dropping to the data-processing devices and display devices included in them. As an example of a display device that is not easily broken, a display device having high adhesiveness between a structure body by which a light-emitting layer is divided and a second electrode layer is known (Patent Document 1).

### Reference

### Patent Document

[Patent Document 1] Japanese Published Patent Application No. 2012-190794

### SUMMARY OF THE INVENTION

An object of one embodiment of the present invention is to provide a novel human interface with excellent operability or to provide a novel data-processing device or display device with excellent operability.

Note that the descriptions of these objects do not disturb the existence of other objects. In one embodiment of the present invention, there is no need to achieve all the objects. Other objects will be apparent from and can be derived from the description of the specification, the drawings, the claims, and the like.

One embodiment of the present invention is a data-processing device including an input/output unit which supplies positional data and to which image data is supplied and an arithmetic unit to which the positional data is supplied and which supplies the image data.

The input/output unit includes a position-input portion and a display portion. The position-input portion is flexible to be bent such that a first region, a second region facing the first region, and a third region between the first region and the second region are formed.

The third region is positioned to overlap with the display portion. The image data is supplied to the display portion, and the display portion displays the image data. The arithmetic unit includes an arithmetic portion and a memory portion storing a program to be executed by the arithmetic portion.

The data-processing device of one embodiment of the present invention includes the flexible position-input portion capable of sensing proximity or touch of an object and supplying the positional data. As mentioned above, the flexible position-input portion can be bent such that the first region, the second region facing the first region, and the third region positioned between the first region and the second region and overlapping with the display portion are formed. With this structure, whether or not a palm or a finger is proximate to or touches the first region or the second region can be determined. As a result, a human interface with high operability can be provided. Furthermore, a novel data-processing device with high operability can be provided.

A data-processing device of one embodiment of the present invention includes an input/output unit which supplies positional data and sensing data including folding data and to which image data is supplied, and an arithmetic unit to which the positional data and the sensing data are supplied and which supplies the image data. Note that folding data includes data which distinguishes between a folded state and an unfolded state of the data-processing device.

The input/output unit includes a position-input portion, a display portion, and a sensor portion. The position-input portion is flexible to be in an unfolded state and a folded state such that a first region, a second region facing the first region, and a third region between the first region and the second region are formed.

The sensor portion includes a folding sensor capable of sensing the folded state of the position-input portion and supplying the sensing data including the folding data. The third region is positioned to overlap with the display portion. The image data is supplied to the display portion, and the display portion displays the image data. The arithmetic unit includes an arithmetic portion and a memory portion storing a program to be executed by the arithmetic portion.

As mentioned above, the data-processing device of one embodiment of the present invention includes the flexible position-input portion capable of sensing proximity or touch of an object and supplying the positional data; and the sensor portion including the folding sensor that can determine whether the flexible position-input portion is in a folded state or an unfolded state. The flexible position-input portion can be bent such that the first region, the second region facing the first region in the folded state, and the third region positioned between the first region and the second region and overlapping with the display portion are formed. With this structure, whether or not a palm or a finger is proximate to or touches the first region or the second region can be determined. As a result, a human interface with high operability can be provided. Furthermore, a novel data-processing device with high operability can be provided.

One embodiment of the present invention is the above data-processing device in which the first region supplies first positional data; the second region supplies second positional data; and the arithmetic portion generates the image data to be displayed on the display portion in accordance with a result of a comparison between the first positional data and the second positional data.

One embodiment of the present invention is the above data-processing device in which the memory portion stores a program which is executed by the arithmetic portion and includes: a first step of determining the length of a first line segment in accordance with the first positional data supplied by the first region; a second step of determining the length of a second line segment in accordance with the second positional data supplied by the second region; a third step of comparing the length of the first line segment and the length of the second line segment are compared with a predetermined length, and then proceeding to a fourth step when only one of the length of the first line segment and the length of the second line segment is longer than the predetermined length or returning to the first step in other cases; a fourth step of determining coordinates of a midpoint of the one of the first and second line segments, which is longer than the predetermined length; a fifth step of generating the image data in accordance with the coordinates of the midpoint; and a sixth step of terminating the program.

As mentioned above, the data-processing device of one embodiment of the present invention includes the flexible position-input portion capable of sensing proximity or touch of an object and supplying the positional data, and the arithmetic portion. The flexible position-input portion can be bent such that the first region, the second region facing the first region, and the third region positioned between the first region and the second region and overlapping with the display portion are formed. The arithmetic portion can compare the first positional data supplied by the first region with the second positional data supplied by the second region and generate the image data to be displayed on the display portion.

With this structure, whether or not a palm or a finger is proximate to or touches the first region or the second region can be determined, and the image data including an image positioned for easy operation (e.g. an image used for operation) can be generated. As a result, a human interface with high operability can be provided. Furthermore, a novel data-processing device with high operability can be provided.

One embodiment of the present invention is the above data-processing device in which the first region supplies first positional data; the second region supplies second positional data; the sensor portion supplies the sensing data including the folding data; and the arithmetic portion generates the image data to be displayed on the display portion in accordance with a result of a comparison between the first positional data and the second positional data and in accordance with the folding data.

One embodiment of the present invention is the above data-processing device in which the memory portion stores a program which is executed by the arithmetic portion and includes: a first step of determining the length of a first line segment in accordance with the first positional data supplied by the first region; a second step of determining the length of a second line segment in accordance with the second positional data supplied by the second region; a third step of comparing the length of the first line segment and the length of the second line segment with a predetermined length, and then proceeding to a fourth step when only one of the length of the first line segment and the length of the second line segment is longer than the predetermined length or returning to the first step in other cases; the fourth step of determining coordinates of a midpoint of the line segment longer than the predetermined length: a fifth step of acquiring the folding data, and then proceeding to a sixth step when the folding data indicates the folded state or proceeding to a seventh step when the folding data indicates the unfolded state; the sixth step of generating first image data in accordance with the coordinates of the midpoint; the seventh step of generating second image data in accordance with the coordinates of the midpoint; and an eighth step of terminating the program.

As mentioned above, the data-processing device of one embodiment of the present invention includes the flexible position-input portion capable of sensing proximity or touch of an object and supplying the positional data; the sensor portion including the folding sensor that can determine whether the flexible position-input portion is in a folded state or an unfolded state; and the arithmetic portion. The flexible position-input portion can be bent such that the first region, the second region facing the first region in the folded state, and the third region positioned between the first region and the second region and overlapping with the display portion are formed. The arithmetic portion can compare the first positional data supplied by the first region with the second positional data supplied by the second region and generate the image data to be displayed on the display portion in accordance with the comparison result and the folding data.

With this structure, whether or not a palm or a finger is proximate to or touches the first region or the second region can be determined, and the image data including a first image positioned for easy operation in the folded state of the position-input portion (e.g., the first image in which an image used for operation is positioned) or a second image positioned for easy operation in the unfolded state of the position-input portion can be generated. As a result, a human interface with high operability can be provided. Furthermore, a novel data-processing device with high operability can be provided.

One embodiment of the present invention is the above data-processing device in which the display portion overlaps with the position-input portion and is flexible to be in an unfolded state and a folded state so that the display portion includes a first area exposed in the folded state and a second area separated from the first area at a fold.

The memory portion stores a program which is executed by the arithmetic portion and includes: a first step of performing initialization; a second step of generating initial image data; a third step of allowing interrupt processing; a fourth step of acquiring the folding data, and then proceeding to a fifth step when the folding data indicates the folded state or proceeding to a sixth step when the folding data indicates the unfolded state; the fifth step of displaying at least part of the supplied image data on the first area; the sixth step of displaying part of the supplied image data on the first area and displaying another part of the supplied image data on the second area; a seventh step of proceeding to an eighth step when a termination instruction is supplied in the interrupt processing or returning to the fourth step when the termination instruction is not supplied in the interrupt processing; and the eighth step of terminating the program.

The interrupt processing includes: a ninth step of proceeding to a tenth step when a page turning instruction is supplied or proceeding to an eleventh step when the page turning instruction is not supplied; the tenth step of generating image data based on the page turning instruction; and the eleventh step of recovering from the interrupt processing.

As mentioned above, above data-processing device of one embodiment of the present invention includes the display portion that is flexible to be in the unfolded state and the folded state and that includes the first area exposed in the folded state and the second area separated from the first area at the fold. Furthermore, the above data-processing device includes the memory portion that stores the program which is executed by the arithmetic portion and includes a step of displaying part of a generated image on the first area and displaying another part of the generated image on the second area in accordance with folding data.

Therefore, in the folded state, part of an image can be displayed on the display portion (first area) that is exposed in the folded state, for example. In the unfolded state, another part of the image that is continuous with or relevant to the part of the image can be displayed on the second area of the display portion that is continuous with the first area, for example. As a result, a human interface with high operability can be provided. Furthermore, a novel data-processing device with high operability can be provided.

In one embodiment of the present invention, a human interface with high operability can be provided. A novel data-processing device with high operability can be provided. A novel data-processing device or a novel display device can be provided. Note that the description of these effects does not disturb the existence of other effects. One embodiment of the present invention does not necessarily achieve all the effects listed above. Other effects will be apparent from and can be derived from the description of the specification, the drawings, the claims, and the like.

### BRIEF DESCRIPTION OF THE DRAWINGS

FIG. 1 is a block diagram illustrating a structure of a data-processing device of an embodiment.

FIGS. 2A, 2B, 2C1, 2C2, and 2D illustrate structures of a data-processing device of an embodiment and a position-input portion.

FIG. 3 is a block diagram illustrating a structure of a data-processing device of an embodiment.

FIGS. 4A to 4C illustrate an unfolded state, a bent state, and a folded state of a data-processing device of an embodiment.

FIGS. 5A to 5E illustrate structures of a data-processing device of an embodiment.

FIGS. 6A1, 6A2, 6B1, and 6B2 illustrate a data-processing device of an embodiment held by a user.

FIGS. 7A and 7B are flow charts showing programs to be executed by an arithmetic portion of a data-processing device of an embodiment.

FIGS. 8A and 8B illustrate a data-processing device of an embodiment held by a user.

FIG. 9 is a flow chart showing a program to be executed by an arithmetic portion of a data-processing device of an embodiment.

FIG. 10 illustrates an example of an image displayed on a display portion of a data-processing device of an embodiment.

FIG. 11 is a flow chart showing a program to be executed by an arithmetic portion of the data-processing device of an embodiment.

FIGS. 12A and 12B are flow charts showing a program to be executed by an arithmetic portion of a data-processing device of an embodiment.

FIGS. 13A to 13C illustrate examples of an image displayed on a display portion of a data-processing device of an embodiment.

FIGS. 14A to 14C illustrate a structure of a display panel that can be used for a display device of an embodiment.

FIGS. 15A and 15B illustrate a structure of a display panel that can be used for a display device of an embodiment.

FIG. 16 illustrates a structure of a display panel that can be used for a display device of an embodiment.

FIGS. 17A to 17H illustrate structures of a data-processing device of an embodiment and a position-input portion.

FIGS. 18A to 18C illustrate structures of a data-processing device of an embodiment and a position-input portion.

FIGS. 19A to 19D illustrate structures of a data-processing device of an embodiment and a position-input portion.

### DETAILED DESCRIPTION OF THE INVENTION

A data-processing device of one embodiment of the present invention includes a flexible position-input portion that can sense proximity or touch of an object and supply positional data. The flexible position-input portion can be bent to provide a first region, a second region facing the first region, and a third region which is positioned between the first region and the second region and overlaps with a display portion.

With this structure, whether or not a palm or a finger is proximate to or touches the first region or the second region can be determined. As a result, a human interface with high operability can be provided. Furthermore, a novel data-processing device with high operability can be provided.

Embodiments will be described in detail with reference to drawings. Note that the present invention is not limited to the description below, and it is easily understood by those skilled in the art that various changes and modifications can be made without departing from the spirit and scope of the present invention. Accordingly, the present invention should not be interpreted as being limited to the content of the embodiments below. Note that in the structures of the invention described below, the same portions or portions having similar functions are denoted by the same reference numerals in different drawings, and description of such portions is not repeated.

### Embodiment 1

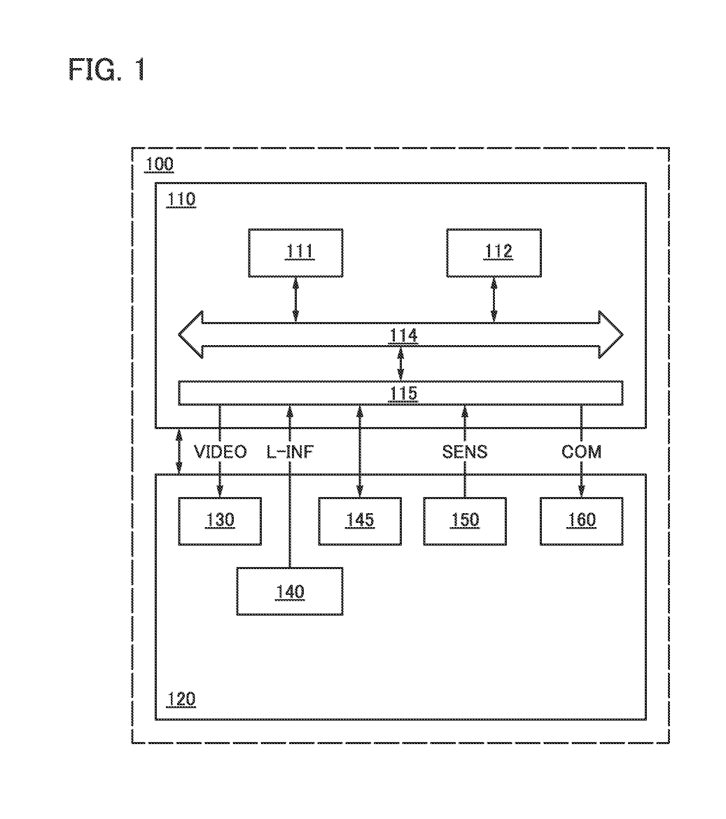

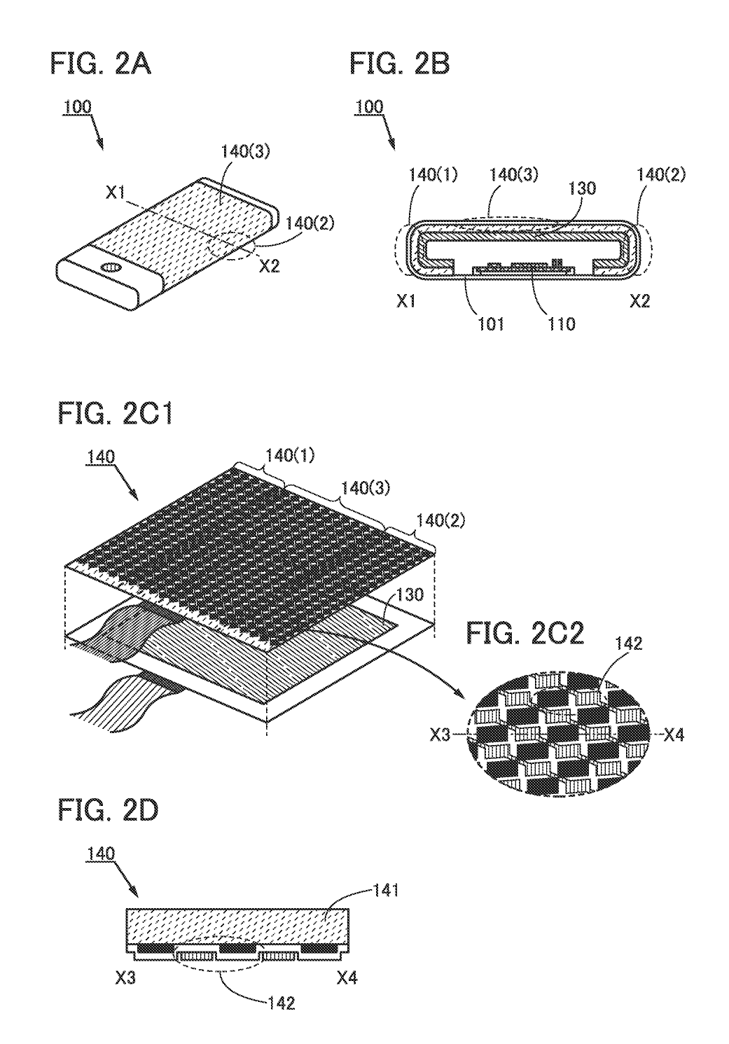

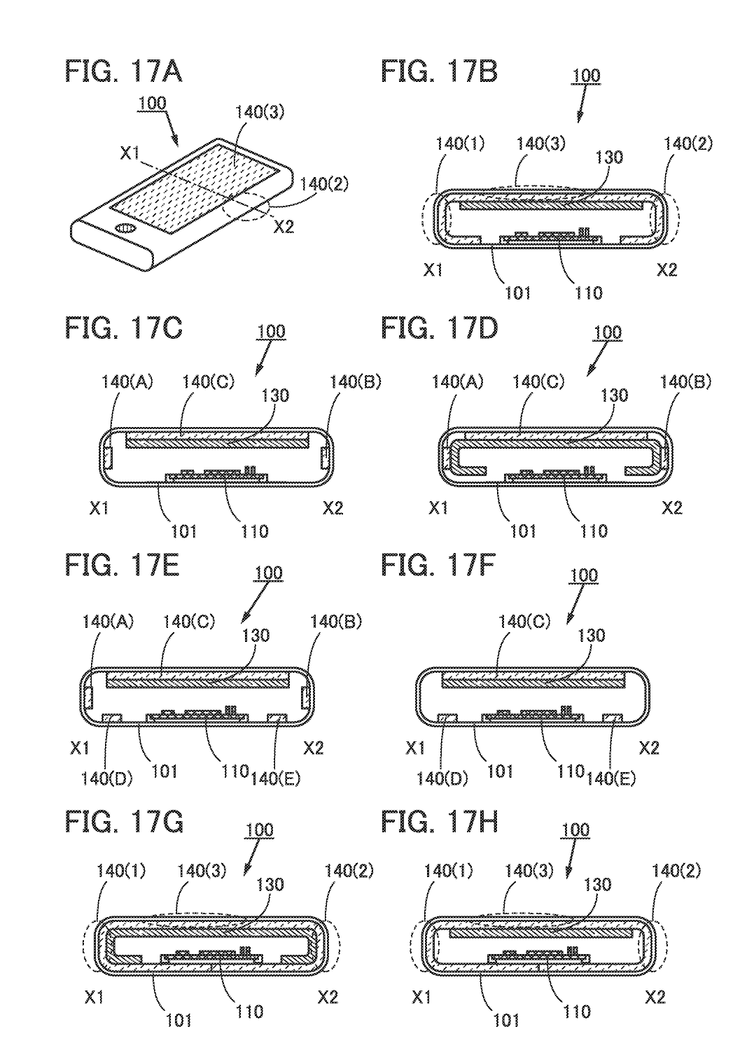

In this embodiment, a structure of a data-processing device of one embodiment of the present invention will be described with reference to FIG. 1, FIGS. 2A, 2B, 2C1, 2C2, and 2D, and FIGS. 17A to 17H.

FIG. 1 shows a block diagram of a structure of a data-processing device 100 of one embodiment of the present invention.

FIG. 2A is a schematic view illustrating the external appearance of the data-processing device 100 of one embodiment of the present invention, and FIG. 2B is a cross-sectional view illustrating a cross-sectional structure along a cutting-plane line X1-X2 in FIG. 2A. Note that a display portion 130 may be provided on not only the front surface but also the side surface of the data-processing device 100 as illustrated in FIG. 2A. Alternatively, as illustrated in FIG. 17A and FIG. 17B that is a cross-sectional view of FIG. 17A, a structure may be employed in which the display portion 130 is not provided on the side surface of the data-processing device 100.

FIG. 2C1 is a schematic view illustrating arrangement of a position-input portion 140 and the display portion 130 that can be employed in the data-processing device 100 of one embodiment of the present invention, and FIG. 2C2 is a schematic view illustrating arrangement of proximity sensors 142 of the position-input portion 140.

FIG. 2D is a cross-sectional view illustrating a cross-sectional structure of the position-input portion 140 along a cutting-plane line X3-X4 in FIG. 2C2.

### <Structure Example of Data-Processing Device>

The data-processing device 100 described here includes a housing 101, an input/output unit 120 which supplies positional data L-INF and to which image data VIDEO is supplied, and an arithmetic unit 110 to which the positional data L-INF is supplied and supplies the image data VIDEO (see FIGS. 1 and 2B).

The input/output unit 120 includes the position-input portion 140 which supplies the positional data L-INF and the display portion 130 to which the image data VIDEO is supplied.

The position-input portion 140 is flexible to be bent such that, for example, a first region 140(1), a second region 140(2) facing the first region 140(1), and a third region 140(3) between the first region 140(1) and the second region 140(2) are formed (see FIG. 2B). Here, the third region 140(3) is in contact with the first region 140(1) and the second region 140(2), and, the first to third regions 140(1) to 140(3) are integrated to construct the position-input portion 140.

On the other hand, these regions may be separately provided with the position-input portions 140. For example, as illustrated in FIGS. 17C, 17D, and 17E, position-input portions 140(A), 140(B), 140(C), 140(D), and 140(E) may be separately provided in the respective regions. Alternatively, a structure may be employed in which some of the position-input portions 140(A), 140(B), 140(C), 140(D), and 140(E) are not provided as illustrated in FIG. 17F. As illustrated in FIGS. 17G and 17H, the position-input portion may be provided to the entire inside surface of the housing.

Note that the second region 140(2) may face the first region 140(1) with or without an inclination.

The display portion 130 is supplied with the image data VIDEO and is positioned so that the display portion 130 and the third region 140(3) overlap with each other (see FIG. 2B). The arithmetic unit 110 includes an arithmetic portion 111 and a memory portion 112 that stores a program to be executed by the arithmetic portion 111 (see FIG. 1).

The data-processing device 100 described here includes the flexible position-input portion 140 sensing proximity or touch of an object. The position-input portion 140 can be bent to provide the first region 140(1), the second region 140(2) facing the first region 140(1), and the third region 140(3) which is positioned between the first region 140(1) and the second region 140(2) and overlaps with the display portion 130. With this structure, whether or not a palm or a finger is proximate to or touches the first region 140(1) or the second region 140(2) can be determined. As a result, a human interface with high operability can be provided. Furthermore, a novel data-processing device with high operability can be provided.

Individual components included in the data-processing device 100 are described below.

### <<Input/Output Unit>>

The input/output unit 120 includes the position-input portion 140 and the display portion 130. An input/output portion 145, a sensor portion 150, a communication portion 160, and the like may be included.

### <<Position-Input Portion>>

The position-input portion 140 supplies the positional data L-INF. The user of the data-processing device 100 can supply the positional data L-INF to the position-input portion 140 by making his/her finger or palm be proximate to or touch the position-input portion 140 and thus can supply a variety of operation instructions to the data-processing device 100. For example, an operation instruction including a termination instruction (an instruction to terminate the program) can be supplied (see FIG. 1).

The position-input portion 140 includes the first region 140(1), the second region 140(2), and the third region 140(3) between the first region 140(1) and the second region 140(2) (see FIG. 2C1). In each of the first region 140(1), the second region 140(2), and the third region 140(3), the proximity sensors 142 are arranged in matrix (see FIG. 2C2).

The position-input portion 140 includes, for example, a flexible substrate 141 and the proximity sensors 142 over the flexible substrate 141 (see FIG. 2D).

The position-input portion 140 can be bent such that the second region 140(2) and the first region 140(1) face each other, for example (see FIG. 2B).

The third region 140(3) of the position-input portion 140 overlaps with the display portion 130 (see FIGS. 2B and 2C1). Note that when the third region 140(3) is positioned closer to the user than the display portion 130 is, the third region 140(3) has a light-transmitting property.

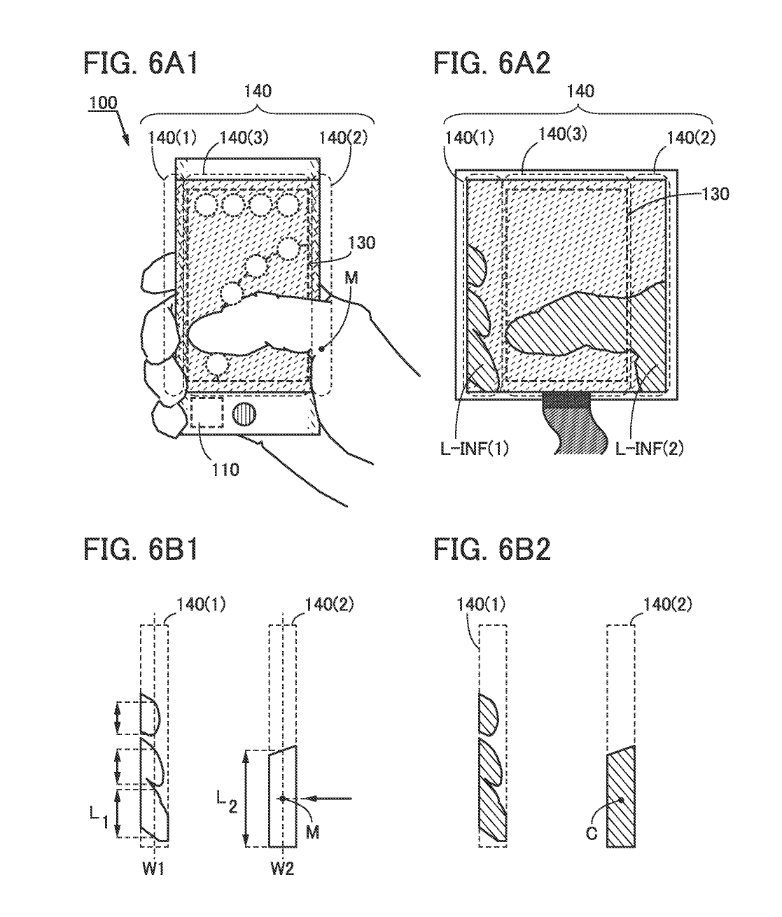

The distance between the second region and the first region in a bent state is arranged to allow the user to hold it in his/her hand (see FIG. 6A1). The distance is, for example, 17 cm or shorter, preferably 9 cm or shorter, further preferably 7 cm or shorter. When the distance is short, the thumb of the holding hand can be used to input the positional data to a wide range of the third region 140(3).

Thus, the user can hold the data-processing device 100 with the thumb joint portion (the vicinity of the thenar) being proximate to or touching one of the first region 140(1) and the second region 140(2), and a finger(s) other than the thumb being proximate to or touching the other.

The shape of the thumb joint portion is different from the shape(s) of the finger(s) other than the thumb; therefore, the first region 140(1) supplies positional data different from that supplied by the second region 140(2). Specifically, the shape of the thumb joint portion is larger than the shape(s) of the finger(s) other than the thumb or is continuous, for example.

The proximity sensor 142 senses proximity or touch of an object (e.g., a finger or a palm), and a capacitor or an imaging element can be used as the proximity sensor. Note that a substrate provided with capacitors arranged in matrix can be referred to as a capacitive touch sensor, and a substrate provided with an imaging element can be referred to as an optical touch sensor.

For the flexible substrate 141, a resin can be used. Specific examples of the resin include a polyester, a polyolefin, a polyamide, a polyimide, a polycarbonate, and an acrylic resin.

Additionally, a glass substrate, a quartz substrate, a semiconductor substrate, or the like, which are thin enough to be flexible, can be used.

Specific examples of a structure that can be employed in the position-input portion 140 are described in Embodiments 6 and 7.

### <<Display Portion>>

The display portion 130 and at least the third region 140(3) of the position-input portion 140 overlap with each other. Not only the third region 140(3) but also the first region 140(1) and/or the second region 140(2) may overlap with the display portion 130.

There is no particular limitation on the display portion 130 as long as the display portion 130 can display the supplied image data VIDEO.

An operation instruction associated with the first region 140(1) and/or the second region 140(2) may be different from an operation instruction associated with the third region 140(3).

The user can thus confirm, from the display portion, the operation instruction associated with the first region 140(1) and/or the second region 140(2). Consequently, a variety of operation instructions can be associated. Moreover, false input of an operation instruction can be reduced.

Specific examples of a structure that can be employed in the display portion 130 are described in Embodiments 6 and 7.

### <<Arithmetic Unit>>

The arithmetic unit 110 includes the arithmetic portion 111, the memory portion 112, an inputioutput interface 115, and a transmission path 114 (see FIG. 1).

The arithmetic unit 110 is supplied with the positional data L-INF and supplies the image data VIDEO.

For example, the arithmetic unit 110 supplies the image data VIDEO including an image used for operation of the data-processing device 100 to the inputioutput unit 120. The display portion 130 displays the image used for operation.

By touching the third region 140(3) overlapping with the display portion 130 with his/her finger, the user can supply the positional data L-INF for selecting the image.

### <<Arithmetic Portion>>

The arithmetic portion 111 executes the program stored in the memory portion 112. For example, in response to supply of the positional data L-INF that is associated with a position in which an image used for operation is displayed, the arithmetic portion 111 executes a program associated with the image.

### <<Memory Portion>>

The memory portion 112 stores the program to be executed by the arithmetic portion 111.

Note that examples of a program to be executed by the arithmetic unit 110 are described in Embodiment 3.

### <<Input/Output Interface and Transmission Path>>

The input/output interface 115 supplies data and is supplied with data.

The transmission path 114 can supply data, and the arithmetic portion 111, the memory portion 112, and the input/output interface 115 are supplied with data. In addition, the arithmetic portion 111, the memory portion 112, and the input/output interface 115 can supply data and the transmission path 114 is supplied with data.

### <<Sensor Portion>>

The sensor portion 150 senses the states of the data-processing device 100 and the circumstances and supplies sensing data SENS (see FIG. 1).

The sensor portion 150 may sense acceleration, a direction, pressure, a navigation satellite system (NSS) signal, temperature, humidity, and the like and supply data thereon. Specifically, the sensor portion 150 may sense a global positioning system (GPS) signal and supply data thereon.

### <<Communication Portion>>

The communication portion 160 supplies data COM supplied by the arithmetic unit 110 to a device or a communication network outside the data-processing device 100. Furthermore, the communication portion 160 acquires the data COM from the device or communication network outside the data-processing device 100 and supplies the data COM.

The data COM can include a variety of instructions and the like. For example, the data COM can include a display instruction to make the arithmetic portion 111 generate or delete the image data VIDEO.

A communication unit for connection to the external device or external communication network, e.g. a hub, a router, or a modem, can be used for the communication portion 160. Note that the connection method is not limited to a method using a wire, and a wireless method (e.g., radio wave or infrared rays) may be used.

### <<Input/Output Portion>>

As the input/output portion 145, for example, a camera, a microphone, a read-only external memory portion, an external memory portion, a scanner, a speaker, or a printer can be used (see FIG. 1).

Specifically, as a camera, a digital camera, digital video camera, or the like can be used.

As an external memory portion, a hard disk, a removable memory, or the like can be used. As a read-only external memory portion, a CD-ROM, a DVD-ROM, or the like can be used.

### <<Housing>>

The housing 101 protects the arithmetic unit 110 and the like from external stress.

The housing 101 can be formed using metal, plastic, glass, ceramics, or the like.

This embodiment can be combined as appropriate with any of other embodiments in this specification.

### Embodiment 2

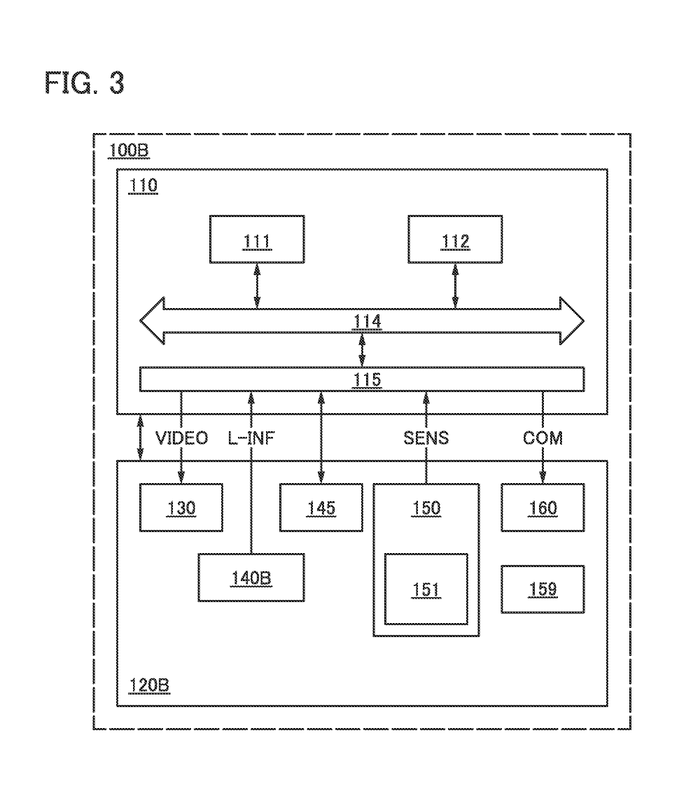

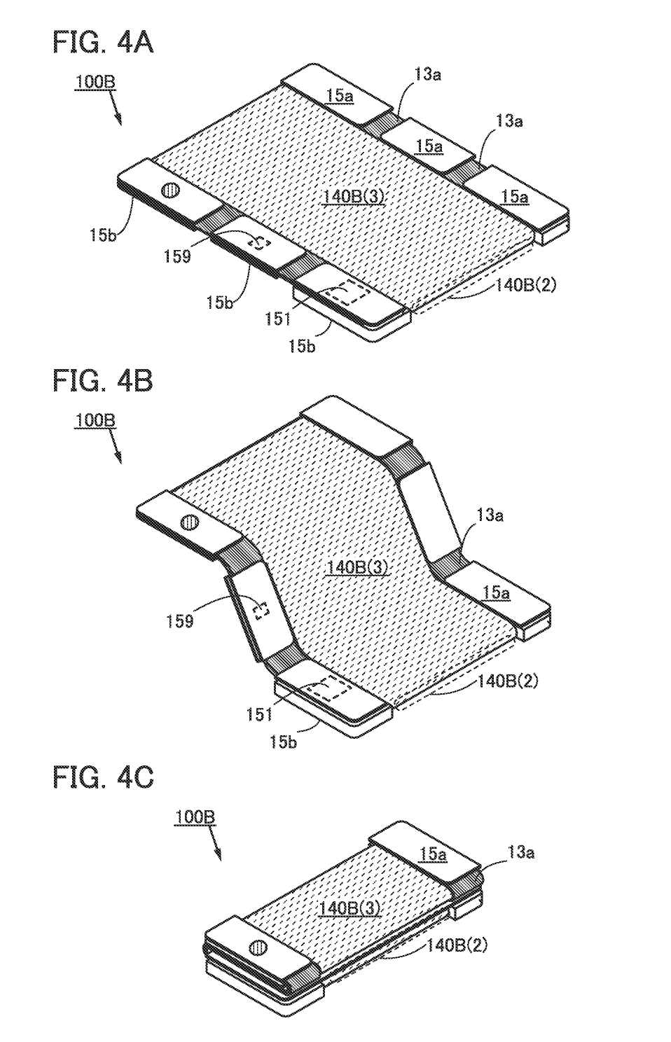

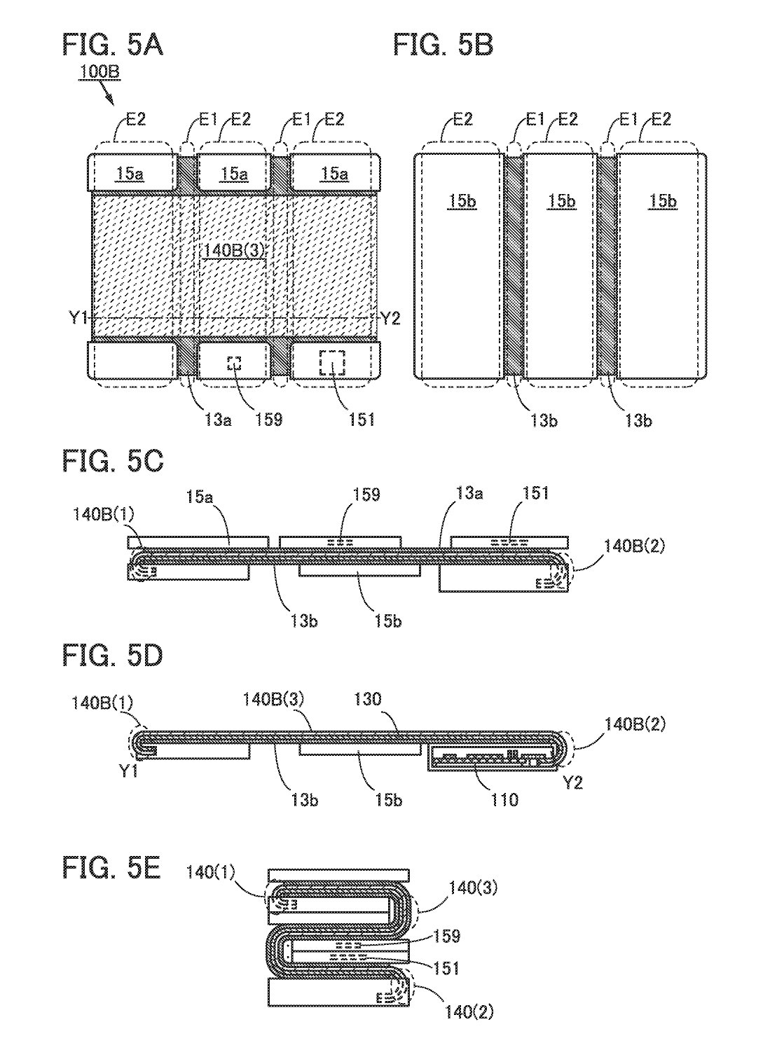

In this embodiment, a structure of a data-processing device of one embodiment of the present invention will be described with reference to FIG. 3, FIGS. 4A to 4C, and FIGS. 5A to 5E.

FIG. 3 shows a block diagram of a structure of a data-processing device 100B of one embodiment of the present invention.

FIGS. 4A to 4C are schematic views illustrating the external appearance of the data-processing device 100B. FIGS. 4A to 4C schematically illustrate the external appearances of the data-processing device 100B in an unfolded state, a bent state, and a folded state, respectively.

FIGS. 5A to 5E are schematic views illustrating the structures of the data-processing device 100B. FIGS. 5A to 5D illustrate the structure in an unfolded state and FIG. 5E illustrates the structure in a folded state.

FIGS. 5A to 5C are a top view, a bottom view, and a side view of the data-processing device 100B, respectively. FIG. 5D is a cross-sectional view illustrating a cross section of the data-processing device 100B taken along a cutting-plane line Y1-Y2 in FIG. 5A. FIG. 5E is a side view of the data-processing device 100B in the folded state.

### <Structure Example of Data-Processing Device>

The data-processing device 100B described here includes an input/output unit 120B which supplies the positional data L-INF and the sensing data SENS including folding data and to which the image data VIDEO is supplied and the arithmetic unit 110 to which the positional data L-INF and the sensing data SENS including the folding data are supplied and which supplies the image data VIDEO (see FIG. 3).

The input/output unit 120B includes a position-input portion 140B, the display portion 130, and the sensor portion 150.

The position-input portion 140B is flexible to be in an unfolded state and a folded state such that a first region 1401(1), a second region 140B(2) facing the first region 140B(1), and a third region 140B(3) between the first region 140B(1) and the second region 140B(2) are formed (see FIGS. 4A to 4C and FIGS. 5A to 5E).

The sensor portion 150 includes a folding sensor 151 capable of sensing a folded state of the position-input portion 140B and supplying the sensing data SENS including the folding data.

The display portion 130 is supplied with the image data VIDEO and is positioned so that the display portion 130 and the third region 140B(3) overlap with each other. The arithmetic unit 110 includes the arithmetic portion Ill and the memory portion 112 that stores the program to be executed by the arithmetic portion 111 (see FIG. 5D).

The data-processing device 100B described here includes the flexible position-input portion 140B sensing a palm or a finger that is proximate to or touches the first region 140B(1), the second region 140B(2) facing the first region 140B(1) in the folded state, and the third region 140B(3) which is positioned between the first region 140B(1) and the second region 140B(2) and overlaps with the display portion 130; and the sensor portion 150 including the folding sensor 151 capable of determining whether the flexible position-input portion 140B is in a folded state or an unfolded state (see FIG. 3 and FIGS. 5A to 5E). With this structure, whether or not a palm or a finger is proximate to or touches the first region 140B(1) or the second region 140B(2) can be determined. As a result, a human interface with high operability can be provided. Furthermore, a novel data-processing device with high operability can be provided.

Individual components included in the data-processing device 100B are described below.

The data-processing device 100B is different from the data-processing device 100 described in Embodiment 1 in that the position-input portion 140B is flexible to be in an unfolded state and a folded state and that the sensor portion 150 in the input/output unit 120B includes the folding sensor 151. Different structures will be described in detail below, and the above description is referred to for the other similar structures.

### <<Input/Output Unit>>

The input/output unit 120B includes the position-input portion 140B, the display portion 130, and the sensor portion 150 including the folding sensor 151. The input/output portion 145, a sign 159, the communication portion 160, and the like may be included. The input/output unit 120B is supplied with data and can supply data (FIG. 3).

### <<Housing>>

The data-processing device 100B has a housing in which a high flexibility portion E1 and a low flexibility portion E2 are alternately provided. In other words, in the housing of the data-processing device 100B, the high flexibility portions E1 and the low flexibility portion E2 are strip-like portions (form stripes) (see FIGS. 5A and 5B).

The above-described structure allows the data-processing device 100B to be folded (see FIGS. 4A to 4C). The data-processing device 100B in a folded state is highly portable. It is possible to fold the data-processing device 100B such that part of the third region 140B(3) of the position-input portion 140B is on the outer side and use only the part of the third region 140B(3) as a display region (see FIG. 4C).

The high flexibility portion E1 and the low flexibility portion E2 can have a shape both sides of which are parallel to each other, a triangular shape, a trapezoidal shape, a fan shape, or the like (see FIG. 5A).

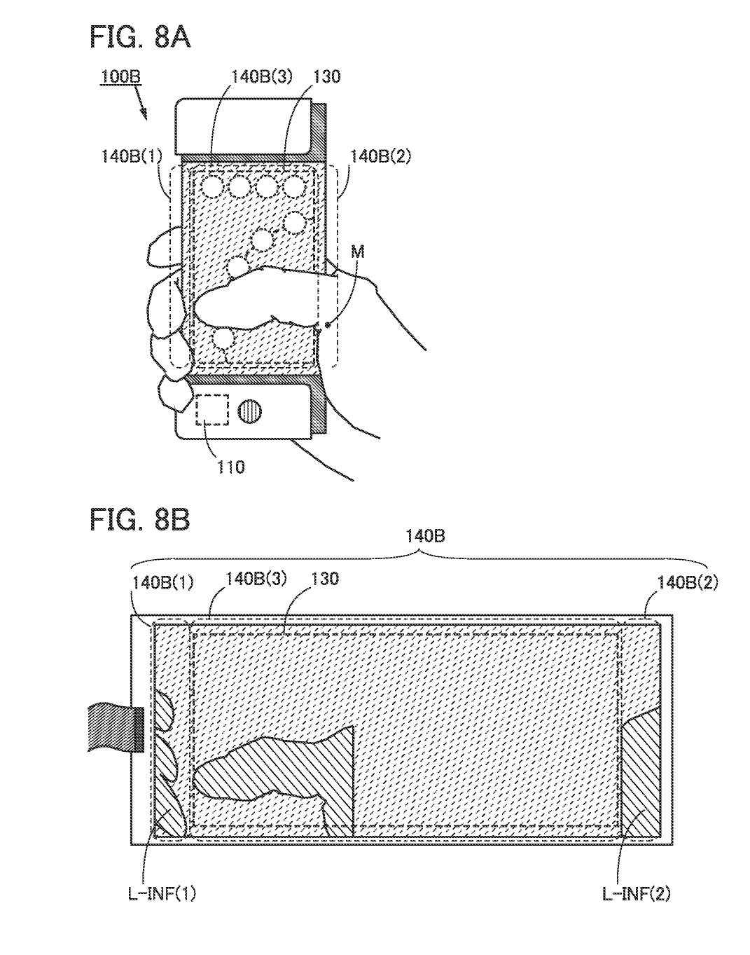

The data-processing device 100B can be folded to a size that allows the data-processing device to be held in one hand of the user. Accordingly, the user can input positional data to the third region 140B(3) with the thumb of his/her hand supporting the data-processing device. In the above manner, the data-processing device that can be operated with one hand can be provided (see FIG. 8A).

Note that because part of the position-input portion 140B is placed on the inner side in a folded state, the user cannot operate such an inner part (see FIG. 4C). Thus, in a folded state, it is possible to stop driving of the inner part. Accordingly, power consumption can be reduced.

The position-input portion 140B in an unfolded state is seamless and has a wide operation region.

The display portion 130 and the third region 140B(3) of the position-input portion overlap with each other (see FIG. 5D). The position-input portion 140B is interposed between a connecting member 13a and a connecting member 13b. The connecting member 13a and the connecting member 13b are interposed between a supporting member 15a and a supporting member 15b (see FIG. 5C).

The display portion 130, the position-input portion 140B, the connecting member 13a, the connecting member 13b, the supporting member 15a, and the supporting member 15b are fixed by any of a variety of methods; for example, it is possible to use an adhesive, a screw, structures that can be fit with each other, or the like.

### <<High Flexibility Portion>>

The high flexibility portion E1 is bendable and functions as a hinge.

The high flexibility portion E1 includes the connecting member 13a and the connecting member 13b overlapping with each other (see FIGS. 5A to 5C).

### <<Low Flexibility Portion>>

The low flexibility portion E2 includes at least one of the supporting member 15a and the supporting member 15b. For example, the low flexibility portion E2 includes the supporting member 15a and the supporting member 15b overlapping with each other. Note that when only the supporting member 15b is included, the weight and thickness of the low flexibility portion E2 can be reduced.

### <<Connecting Member>>

The connecting member 13a and the connecting member 13b are flexible. For example, flexible plastic, metal, alloy and/or rubber can be used as the connecting member 13a and the connecting member 13b. Specifically, silicone rubber can be used as the connecting member 13a and the connecting member 13b.

### <<Supporting Member>>

Any one of the supporting member 15a and the supporting member 15b has lower flexibility than the connecting member 13a and the connecting member 13b. The supporting member 15a or the supporting member 15b can increase the mechanical strength of the position-input portion 140B and protect the position-input portion 140B from breakage.

For example, plastic, metal, alloy, rubber, or the like can be used as the supporting member 15a or the supporting member 15b. The connecting member 13a, the connecting member 13b, the supporting member 15a, or the supporting member 15b formed using plastic, rubber, or the like can be lightweight or break-resistant.

Specifically, engineering plastic or silicone rubber can be used. Stainless steel, aluminum, magnesium alloy, or the like can also be used for the supporting member 15a and the supporting member 15b.

### <<Position-Input Portion>>

The position-input portion 140B can be in an unfolded state and a folded state (see FIGS. 4A to 4C).

The third region 140B(3) in an unfolded state is positioned on a top surface of the data-processing device 100B (see FIG. 5D), and the third region 140B(3) in a folded state is positioned on the top surface and a side surface of the data-processing device 100B (see FIG. 5E).

The usable area of the unfolded position-input portion 140B is larger than that of the folded position-input portion 140B.

When the position-input portion 140B is folded, an operation instruction that is different from an operation instruction associated with the top surface of the third region 140B(3) can be associated with the side surface. Note that the operation instruction that is different from an operation instruction associated with the second region 140B(2) may be associated with the side surface. In this manner, a complex operation instruction can be given with the use of the position-input portion 140B.

The position-input portion 140B supplies the positional data L-INF (FIG. 3).

The position-input portion 140B is provided between the supporting member 15a and the supporting member 15b. The position-input portion 140B may be interposed between the connecting member 13a and the connecting member 13b.

The position-input portion 140B includes the first region 140B(1), the second region 140B(2), and the third region 140B(3) between the first region 140B(1) and the second region 140B(2) (see FIG. 5D).

The position-input portion 140B includes a flexible substrate and proximity sensors over the flexible substrate. In each of the first region 140B(1), the second region 140B(2), and the third region 140B(3), the proximity sensors are arranged in matrix.

Specific examples of a structure that can be employed in the position-input portion 140B are described in Embodiments 6 and 7.

### <<Sensor Portion and Sign>>

The data-processing device 100B includes the sensor portion 150. The sensor portion 150 includes the folding sensor 151 (see FIG. 3).

The folding sensor 151 and the sign 159 are positioned in the data-processing device 100B so that a folded state of the position-input portion 140B can be sensed (FIGS. 4A and 4B and FIGS. 5A, 5C, and 5E).

In a state where the position-input portion 140B is unfolded, the sign 159 is positioned away from the folding sensor 151 (see FIG. 4A and FIGS. 5A and 5C).

In a state where the position-input portion 140B is bent at the connecting members 13a, the sign 159 is close to the folding sensor 151 (see FIG. 4B).

In a state where the position-input portion 140B is folded at the connecting members 13a, the sign 159 faces the folding sensor 151 (see FIG. 5E).

When the sensor portion 150 senses the sign 159 and determines that the position-input portion 140B is in a folded state, it supplies the sensing data SENS including folding data.

### <<Display Portion>>

The display portion 130 and at least part of the third region 140B(3) of the position-input portion 140B overlap with each other. The display portion 130 can display the supplied image data VIDEO.

Since the display portion 130 is flexible, it can be unfolded and folded with the position-input portion 140B overlapping with the display portion 130. Thus, seamless display with excellent browsability can be performed by the display portion 130.

Specific examples of a structure that can be employed in the flexible display portion 130 are described in Embodiments 6 and 7.

### <<Arithmetic Unit>>

The arithmetic unit 110 includes the arithmetic portion 111, the memory portion 112, the input/output interface 115, and the transmission path 114 (see FIG. 3).

This embodiment can be combined as appropriate with any of other embodiments in this specification.

### Embodiment 3

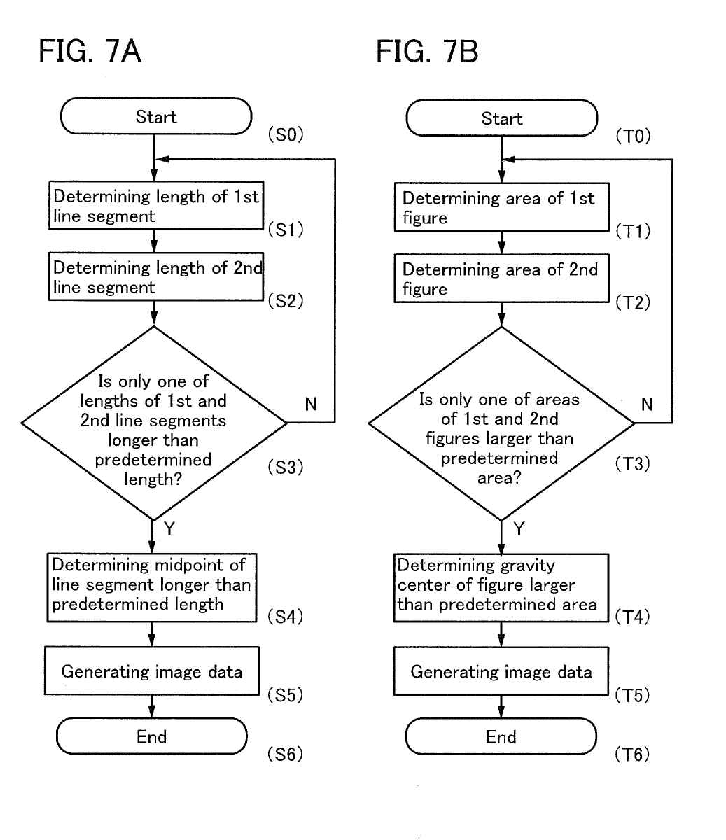

In this embodiment, a structure of a data-processing device of one embodiment of the present invention will be described with reference to FIG. 1, and FIGS. 2A, 2B, 2C1, 2C2, and 2D, FIGS. 6A1, 6A2, 6B1, and 6B2, FIGS. 7A and 7B, FIGS. 18A to 18C, and FIGS. 19A to 19D.

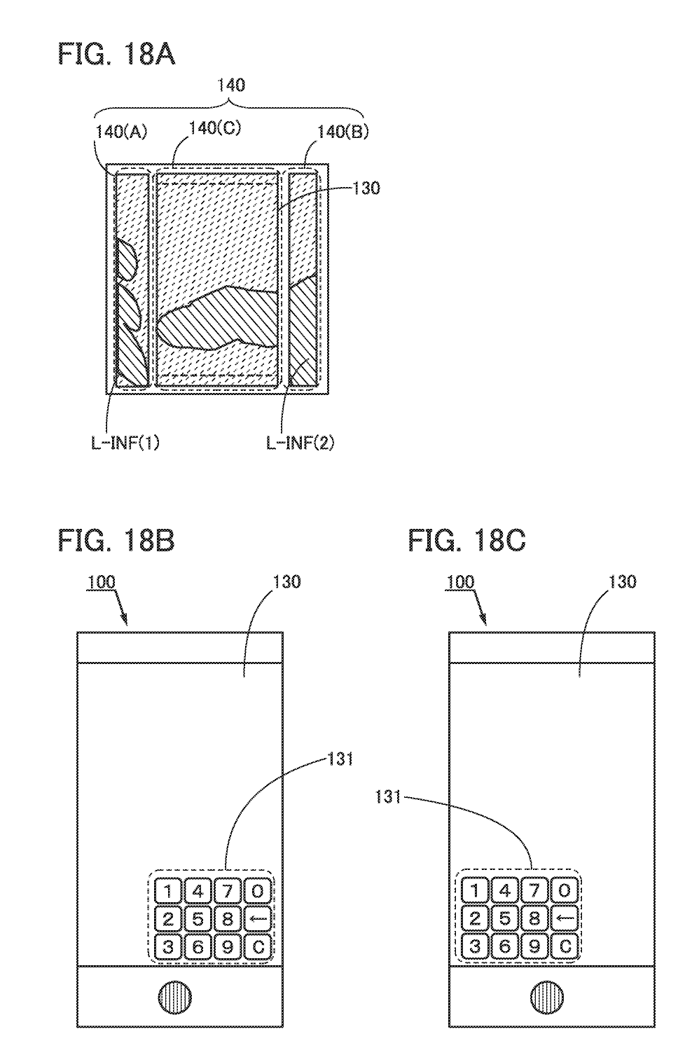

FIGS. 6A1, 6A2, 6B1, and 6B2 illustrate a state where the data-processing device 100 of one embodiment of the present invention is held by a user. In this case, the position-input portion 140 has the third region 140(3) between the first and second regions 140(1) and 140(2) which face to each other. FIG. 6A1 illustrates the external appearance of the data-processing device 100 held by a user, and FIG. 6A2 illustrates a development view of the position-input portion 140 illustrated in FIG. 6A1 and shows the portion in which the proximity sensor senses the palm and fingers. Note that the case where separate position-input portions 140(A), 140(B), and 140(C) are used is illustrated in FIG. 18A. The description for the case of FIG. 6A2 can be applied to the case of FIG. 18A.

FIG. 6B1 is a schematic view where solid lines denote results of edge sensing processing of first positional data L-INF(1) sensed by the first region 140(1) and second positional data L-INF(2) sensed by the second region 140(2). FIG. 6B2 is a schematic view where hatching patterns denote results of labelling processing of the first positional data L-INF(1) and the second positional data L-INF(2).

FIGS. 7A and 7B are flow charts showing the programs to be executed by the arithmetic portion 111 of the data-processing device of one embodiment of the present invention.

### <Structure Example of Data-Processing Device>

The data-processing device 100 described here is different from that in Embodiment 1 in that the first region 140(1) supplies the first positional data L-INF(1) and the second region 140(2) supplies the second positional data L-INF(2) (see FIG. 6A2); and the image data VIDEO to be displayed on the display portion 130 with which the third region 140(3) overlaps is generated by the arithmetic portion 111 in accordance with results of a comparison between the first positional data L-INF(1) and the second positional data L-INF(2) (see FIG. 1, FIGS. 2A, 2B, 2C1, 2C2, and 2D, and FIGS. 6A1, 6A2, 6B 1, and 6B2). Different structures will be described in detail below, and the above description is referred to for the other similar structures.

Individual components included in the data-processing device 100 are described below.

### <<Position-Input Portion>>

The position-input portion 140 is flexible to be bent such that the first region 140(1), the second region 140(2) facing the first region 140(1), and the third region 140(3) provided between the first region 140(1) and the second region 140(2) and overlapping with the display portion 130 are formed (see FIG. 2B).

The first region 140(1) and the second region 140(2) of the data-processing device 100 held by a user sense part of the user's palm and part of the user's fingers. Specifically, the first region 140(1) supplies the first positional data L-INF(1) including data on contact positions of part of the index finger, the middle finger, and the ring finger, and the second region 140(2) supplies the second positional data L-INF(2) including data on a contact position of the thumb joint portion (the vicinity of the thenar). Note that the third region 140(3) supplies data on a contact position of the thumb.

### <<Display Portion>>

The display portion 130 and the third region 140(3) overlap with each other (see FIGS. 6A1 and 6A2). The display portion 130 is supplied with the image data VIDEO and displays the image data VIDEO. For example, the image data VIDEO including an image used for operation of the data-processing device 100 can be displayed. A user can input positional data for selecting the image, by making his/her thumb be proximate to or touch the third region 140(3) overlapping with the image.

For example, a keyboard 131, icons, and the like are displayed on the right side as illustrated in FIG. 18B when operation is performed with the right hand. The keyboard 131, icons, and the like are displayed on the left side as illustrated in FIG. 18C when operation is performed with the left hand. In this way, operation with fingers is facilitated.

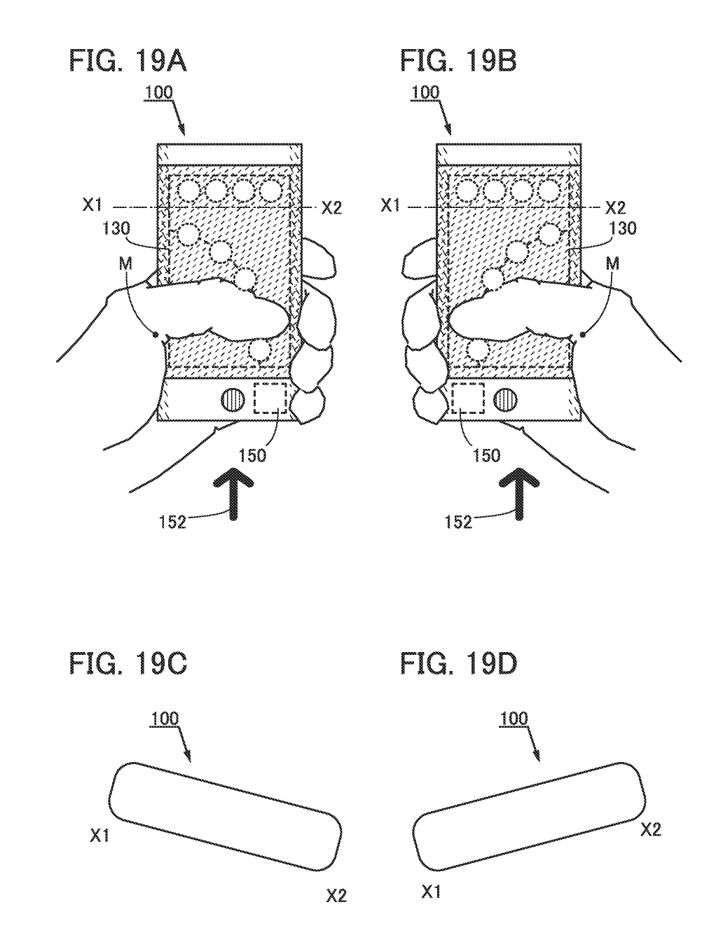

Note that a displayed image may be changed in response to sensing of inclination of the data-processing device 100 by the sensor portion 150 that senses acceleration. For example, a case is considered where the left end of the data-processing device 100 held in the left hand as illustrated in FIG. 19A is positioned higher than the right end when seen in the direction denoted by an arrow 152 (see, FIG. 19C). Here, in response to sensing of this inclination, a screen for the left hand is displayed as illustrated in FIG. 18C. In a similar manner, a case is considered where the right end of the data-processing device 100 held in the right hand as illustrated in FIG. 19B is positioned higher than the left end when seen in the direction denoted by the arrow 152 (see, FIG. 19D). Here, in response to sensing of this inclination, a screen for the right hand is displayed as illustrated in FIG. 18B. The display positions of a keyboard, icons, and the like may be controlled in this manner.

Note that without sensing of information, the screen may be switched between an operation screen for the right hand and an operation screen for the left hand by the user.

### <<Arithmetic Portion>>

The arithmetic portion 111 is supplied with the first positional data L-INF(1) and the second positional data L-INF(2) and generates the image data VIDEO to be displayed on the display portion 130 in accordance with results of a comparison between the first positional data L-INF(1) and the second positional data L-INF(2).

### <Program>

The data-processing device described here has the memory portion storing a program which is executed by the arithmetic portion 111 and includes the following six steps (see FIG. 7A). Explanation on the program is given below.

### First Example

In a first step, the length of a first line segment is determined using the first positional data L-INF(1) supplied by the first region 140(1) (S1 in FIG. 7A).

In a second step, the length of a second line segment is determined using the second positional data L-INF(2) supplied by the second region 140(2) (S2 in FIG. 7A).

In a third step, the length of the first line segment and the length of the second line segment are compared with a predetermined length. The program proceeds to a fourth step when only one of the lengths of the first and second line segments is longer than the predetermined length. The program proceeds to the first step in other cases (S3 in FIG. 7A). Note that it is preferable that the predetermined length be longer than or equal to 2 cm and shorter than or equal to 15 cm, and it is particularly preferable that the predetermined length be longer than or equal to 5 cm and shorter than or equal to 10 cm.

In the fourth step, the coordinates of the midpoint of the line segment longer than the predetermined length are determined (S4 in FIG. 7A).

In a fifth step, the image data VIDEO to be displayed on the display portion 130 is generated in accordance with the coordinates of the midpoint (S5 in FIG. 7A).

The program is terminated in a sixth step (S6 in FIG. 7A).

Note that a step in which the display portion 130 displays the predetermined image data VIDEO (also referred to as initial image) may be included before the first step. In that case, the predetermined image data VIDEO can be displayed when both the length of the first line segment and that of the second line segment are longer or shorter than the predetermined length.

Individual processes executed by the arithmetic portion with the use of the program are described below.

### <<Method for Determining Coordinates of Midpoint of Line Segment>>

Hereinafter, a method for determining the length of the first line segment and the length of the second line segment using the first positional data L-INF(1) and the second positional data L-INF(2), respectively, is described. A method for determining the coordinates of the midpoint of a line segment is also described.

Specifically, an edge sensing method for determining the length of a line segment is described.

Note that although description is given of an example in which an imaging element is used as the proximity sensor, a capacitor or the like may be used as the proximity sensor.

Here, a value acquired by an imaging pixel arranged at coordinates (x, y) is described as f_{(x, y)}. It is preferable that a value obtained by subtracting a background value from a value sensed by the imaging pixel be used as f_{(x, y)} because noise can be removed.

### <<Method for Extracting Edge (Contour)>>

Equation (1) below expresses the sum Δ_{(x, y)} of differences between a value sensed by the imaging pixel with the coordinates (x, y) and values sensed by imaging pixels with coordinates (x−1, y), coordinates (x+1, y), coordinates (x, y−1), and coordinates (x, y+1), which are adjacent to the coordinates (x, y).

Δ_{(x,y)}=4·f_{(x,y)}−{f_{(x,y-1)}+f_{(x,y+1)}+f_{(x-1,y)}+f_{(x+1,y)}} (1)

Acquiring the Δ_{(x,y)} of all of the imaging pixels in the first region 140(1), the second region 140(2), and the third region 140(3) and imaging the results gives an edge (contour) of a finger or a palm that is proximate to or touches the first region 140(1) and the second region 140(2) as illustrated in FIGS. 6A2 and 6B 1.

### <<Method for Determining Length of Line Segment>>

The coordinates of intersections between the contour extracted to the first region 140(1) and a predetermined line segment W1 are determined, and the predetermined line segment W1 is cut at the intersections to be divided into a plurality of line segments. The line segment having the longest length among the plurality of line segments is the first line segment and its length is referred to as L1 (see FIG. 6B1).

The coordinates of intersections between the contour extracted to the second region 140(2) and a predetermined line segment W2 are determined, and the predetermined line segment W2 is cut at the intersections to be divided into a plurality of line segments. The line segment having the longest length among the plurality of line segments is the second line segment and its length is referred to as L2.

### <<Method for Determining Coordinates of Midpoint>>

Next, L1 and L2 are compared with each other, the longer one is selected, and the coordinates of a midpoint M are calculated. In this embodiment, L2 is longer than L1; thus, the coordinates of the midpoint M of the second line segment are determined.

<<Image Data Generated in Accordance with Coordinates of Midpoint>>

The coordinates of the midpoint M can be associated with the position of the thumb joint portion, the movable range of the thumb, or the like. In this manner, image data that facilitates operation of the data-processing device 100 can be generated in accordance with the coordinates of the midpoint M.

For example, it is possible to generate the image data VIDEO so that an image used for operation is positioned in the movable range of the thumb over the display portion 130. Specifically, images used for operation (denoted by circles) can be positioned on a circular arc whose center is in the vicinity of the midpoint M (see FIG. 6A1). Among images used for operation, images that are used frequently may be positioned on a circular arc and images that are used less frequently may be positioned inside or outside the circular arc. As a result, a human interface with high operability can be provided. Furthermore, a novel data-processing device with high operability can be provided.

### Second Example

The program described here is different from the aforementioned one in containing the following six steps in which the area of a first figure and the area of a second figure are used instead of the length of the first line segment and the length of the second line segment (see FIG. 7B). Different processes will be described in detail below, and the above description is referred to for the other similar processes.

In a first step, the area of the first figure is determined using the first positional data L-INF(1) supplied by the first region 140(1) (T1 in FIG. 7B).

In a second step, the area of the second figure is determined using the second positional data L-INF(2) supplied by the second region 140(2) (T2 in FIG. 7B).

In a third step, the area of the first figure and the area of the second figure are compared with a predetermined area. The program proceeds to a fourth step when only one of the areas of the first and second figures is larger than the predetermined area. The program proceeds to the first step in other cases (T3 in FIG. 7B). Note that it is preferable that the predetermined area be larger than or equal to 1 cm² and smaller than or equal to 8 cm², and it is particularly preferable that the predetermined area be larger than or equal to 3 cm² and smaller than or equal to 5 cm².

In the fourth step, the coordinates of the center of gravity of the figure whose area is larger than the predetermined area are determined (T4 in FIG. 7B).

In a fifth step, the image data VIDEO to be displayed on the display portion 130 with which the third region overlaps is generated in accordance with the coordinates of the center of gravity (T5 in FIG. 7B).

The program is terminated in a sixth step (T6 in FIG. 7B).

Individual processes executed by the arithmetic portion with the use of the program are described below.

### <<Method for Determining Center of Gravity of Figure>>

Hereinafter, a method for determining the area of the first figure and the area of the second figure using the first positional data L-INF(1) and the second positional data L-INF(2), respectively, is described. A method for determining the center of gravity of a figure is also described.

Specifically, labeling processing for determining the area of a figure is described.

Note that although description is given of an example in which an imaging element is used as the proximity sensor, a capacitor or the like may be used as the proximity sensor.

Here, a value acquired by an imaging pixel arranged at coordinates (x, y) is defined as f_{(x, y)}. It is preferable that a value obtained by subtracting a background value from a value sensed by the imaging pixel be used as f_{(x, y)} because noise can be removed.

### <<Labelling Processing>>

In the case where one imaging pixel and an adjacent imaging pixel in the first region 140(1) or the second region 140(2) each acquire a value f_{(x, y)} exceeding a predetermined threshold value, the region where the region occupied by these imaging pixels is regarded as one figure. Note that when f_{(x, y)} can take 256 in maximum, for example, it is preferable that the predetermined threshold value be greater than or equal to 0 and less than or equal to 150, and it is particularly preferable that the predetermined threshold value be greater than or equal to 0 and less than or equal to 50.

The above processing is performed on all of the imaging pixels in the first region 140(1) and the second region 140(2), and imaging of the results is carried out to give the regions in which adjacent imaging pixels each exceeds the predetermined threshold value as shown in FIGS. 6A2 and 6B2. The figure having the largest area among figures in the first region 140(1) is referred to as the first figure. The figure having the largest area among figures in the second region 140(2) is referred to as the second figure.

### <<Determination of Center of Gravity of Figure>>

The area of the first figure and that of the second figure are compared, the larger one is selected, and the center of gravity is calculated. Coordinates C_{(X, Y)} of the center of gravity can be calculated using Equation (2) below.

$${C}_{( X , Y )} = ( \frac{1}{n} {\sum }_{i = 0}^{n - 1} {x}_{i} , \frac{1}{n} {\sum }_{i = 0}^{n - 1} {y}_{i} ) \qquad ( 2 )$$

In Equation (2), xᵢ and yᵢ represent the x and y coordinates of each of the n imaging pixels forming one figure. The area of the second figure is larger than that of the first figure in the case shown in FIG. 6B2; thus, the coordinates of the center of gravity C of the second figure are employed.

<<Image Data Generated in Accordance with Coordinates of Center of Gravity>>

The coordinates of the center of gravity C can be associated with the position of the thumb joint portion, the movable range of the thumb, or the like. In this manner, image data that facilitates operation of the data-processing device 100 can be generated in accordance with the coordinates of the center of gravity C.

As mentioned above, the data-processing device 100 described here includes the flexible position-input portion 140 capable of sensing proximity or touch of an object and supplying the positional data L-INF, and the arithmetic portion 111. The flexible position-input portion 140 can be bent to form the first region 140(1), the second region 140(2) facing the first region 140(1), and the third region 140(3) which is positioned between the first region 140(1) and the second region 140(2) and overlaps with the display portion 130. The arithmetic portion 111 can compare the first positional data L-INF(1) supplied by the first region 140(1) with the second positional data L-INF(2) supplied by the second region 140(2) and generate the image data VIDEO to be displayed on the display portion 130.

With this structure, whether or not a palm or a finger is proximate to or touches the first region 140(1) or the second region 140(2) can be determined, and the image data VIDEO including an image (e.g., an image used for operation) positioned for easy operation can be generated. As a result, a human interface with high operability can be provided. Furthermore, a novel data-processing device with high operability can be provided.

This embodiment can be combined as appropriate with any of other embodiments in this specification.

### Embodiment 4

In this embodiment, a structure of the data-processing device of one embodiment of the present invention will be described with reference to FIG. 3, FIGS. 4A to 4C. FIGS. 8A and 8B, FIG. 9, FIG. 10, and FIG. 11.

FIG. 8A illustrates the data-processing device 100B in a folded state held by a user, and FIG. 8B illustrates a development view of the data-processing device 100B illustrated in FIG. 8A and shows the portion in which the proximity sensor senses the palm and fingers.

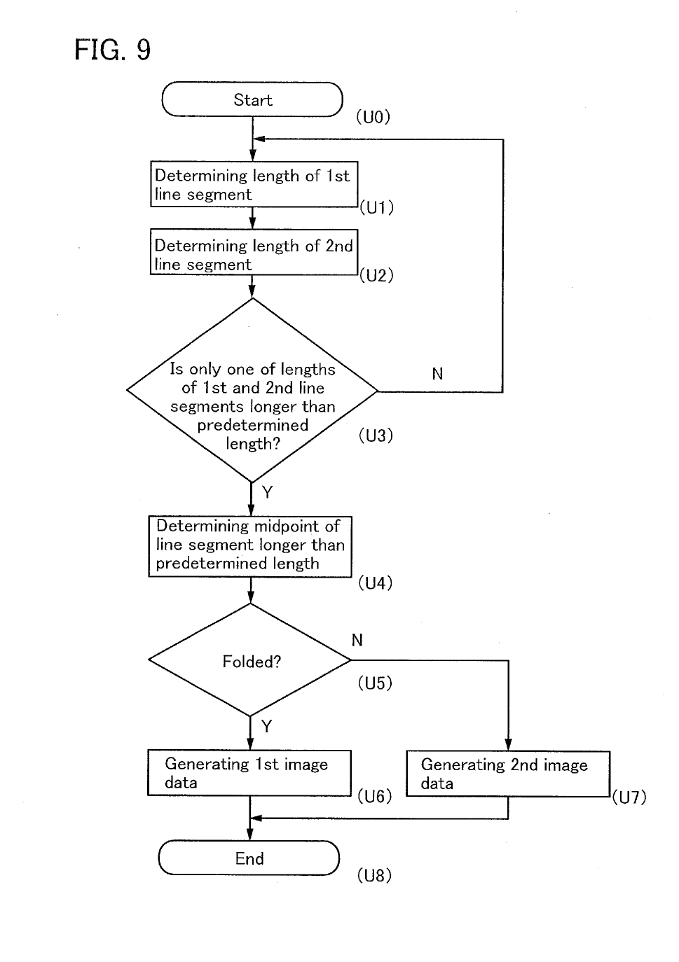

FIG. 9 is a flow chart showing the program to be executed by the arithmetic portion 111 of the data-processing device 100B of one embodiment of the present invention.

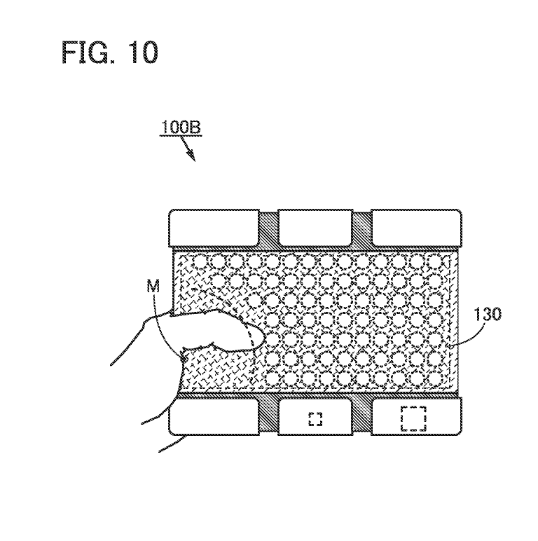

FIG. 10 illustrates an example of an image displayed on the display portion 130 of the data-processing device 100B of one embodiment of the present invention.

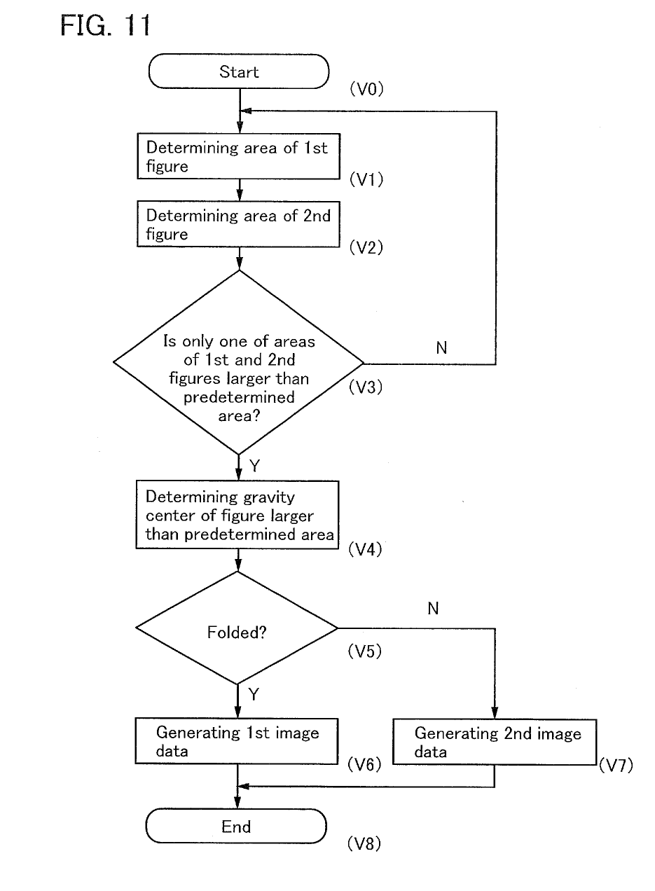

FIG. 11 is a flow chart showing the program to be executed by the arithmetic portion 111 of the data-processing device 100B of one embodiment of the present invention.

### <Structure Example of Data-Processing Device>

The data-processing device 100B described here is different from that in Embodiment 2 in that the first region 140B(1) of the position-input portion 140B supplies the first positional data L-INF(1); the second region 140B(2) supplies the second positional data L-INF(2) (see FIG. 8B); the sensor portion 150 supplies the sensing data SENS including folding data; and the image data VIDEO to be displayed on the display portion 130 is generated by the arithmetic portion 111 in accordance with the sensing data SENS including the folding data and results of a comparison between the first positional data L-INF(1) and the second positional data L-INF(2) (see FIG. 3, FIGS. 4A to 4C, and FIGS. 8A and 8B). Different structures will be described in detail below, and the above description is referred to for the other similar structures.

Individual components included in the data-processing device 100B are described below.

### <<Position-Input Portion>>

The position-input portion 140B is flexible to be in an unfolded state and a folded state such that the first region 140B(1), the second region 140B(2) facing the first region 140B(1), and the third region 140B(3) provided between the first region 140B(1) and the second region 140B(2) and overlapping with the display portion 130 are formed (see FIGS. 4A to 4C).

The first region 140B(1) and the second region 140B(2) sense part of the user's palm and part of the user's fingers. Specifically, the first region 140B(1) supplies the first positional data L-INF(1) including data on contact positions of part of the index finger, the middle finger, and the ring finger, and the second region 140B(2) supplies the second positional data L-INF(2) including data on a contact position of the thumb joint portion. Note that the third region 140B(3) supplies data on a contact position of the thumb.

### <<Display Portion>>

The display portion 130 and the third region 140B(3) overlap with each other (see FIGS. 8A and 8B). The display portion 130 is supplied with the image data VIDEO and can display an image used for operation of the data-processing device 100B, for example. A user can input positional data for selecting the image, by making his/her thumb be proximate to or touch the third region 140B(3) overlapping with the image.

### <<Arithmetic Portion>>

The arithmetic portion 111 is supplied with the first positional data L-INF(1) and the second positional data L-INF(2) and generates the image data VIDEO to be displayed on the display portion 130 in accordance with results of a comparison between the first positional data L-INF(1) and the second positional data L-INF(2).

### <Program>

The data-processing device described here has the memory portion storing a program which is executed by the arithmetic portion 111 and includes the following seven steps (see FIG. 9). Explanation on the program is given below.

### First Example

In a first step, the length of the first line segment is determined using the first positional data supplied by the first region (U1 in FIG. 9).

In a second step, the length of the second line segment is determined using the second positional data supplied by the second region (U2 in FIG. 9).

In a third step, the length of the first line segment and the length of the second line segment are compared with a predetermined length. The program proceeds to a fourth step when only one of the lengths of the first and second line segments is longer than the predetermined length. The program proceeds to the first step in other cases (U3 in FIG. 9). Note that it is preferable that the predetermined length be longer than or equal to 2 cm and shorter than or equal to 15 cm, and it is particularly preferable that the predetermined length be longer than or equal to 5 cm and shorter than or equal to 10 cm.

In the fourth step, the coordinates of the midpoint of the line segment longer than the predetermined length are determined (U4 in FIG. 9).

In a fifth step, folding data is acquired. The program proceeds to a sixth step when the folding data indicates a folded state. The program proceeds to a seventh step when the folding data indicates an unfolded state (U5 in FIG. 9).

In the sixth step, first image data to be displayed on the display portion is generated in accordance with the coordinates of the midpoint (U6 in FIG. 9).

In the seventh step, second image data to be displayed on the display portion is generated in accordance with the coordinates of the midpoint (U7 in FIG. 9).

The program is terminated in an eighth step (U8 in FIG. 9).

In the data-processing device 100B described here, a step in which the predetermined image data VIDEO is generated by the arithmetic portion 111 and displayed on the display portion 130 may be included before the first step. In that case, the predetermined image data VIDEO can be displayed when both the length of the first line segment and that of the second line segment are longer or shorter than the predetermined length in the third step.

Individual processes executed by the arithmetic portion with the use of the program are described below.

The program to be executed by the arithmetic portion 111 is different from the program explained in Embodiment 3 in that in the fifth step, the process is branched in accordance with the folded state. Different processes will be described in detail below, and the above description is referred to for the other similar processes.

### <<Process for Generating First Image Data>>

When the acquired folding data indicates the folded state, the arithmetic portion 111 generates the first image data. For example, in a manner similar to that of the fifth step of the program explained in Embodiment 3, first image data VIDEO to be displayed on the display portion 130 with which the third region 140B(3) in the folded state overlaps is generated in accordance with the coordinates of the midpoint.

The coordinates of the midpoint M can be associated with the position of the thumb joint portion, the movable range of the thumb, or the like. In this manner, image data that facilitates operation of the data-processing device 100B in the folded state can be generated in accordance with the coordinates of the midpoint M.

For example, it is possible to generate the first image data VIDEO so that an image used for operation is positioned in the movable range of the thumb over the display portion 130. Specifically, images used for operation (denoted by circles) can be positioned on a circular arc whose center is in the vicinity of the midpoint M (see FIG. 8A). Among images used for operation, images that are used frequently may be positioned on a circular are and images that are used less frequently may be positioned inside or outside the circular arc. As a result, a human interface with high operability can be provided in the data-processing device 100B in the folded state. Furthermore, a novel data-processing device with high operability can be provided.

### <<Process for Generating Second Image Data>>

When the acquired folding data indicates the unfolded state, the arithmetic portion 111 generates the second image data. For example, in a manner similar to that of the fifth step of the program explained in Embodiment 3, the first image data VIDEO to be displayed on the display portion 130 with which the third region 140B(3) overlaps is generated in accordance with the coordinates of the midpoint. The coordinates of the midpoint M can be associated with the position of the thumb joint portion, the movable range of the thumb, or the like.

For example, it is possible to generate second image data VIDEO so that an image used for operation is not positioned in an area which overlaps with the movable range of the thumb overlaps. Specifically, images used for operation (denoted by circles) can be positioned outside a circular arc whose center is in the vicinity of the midpoint M (see FIG. 10). The data-processing device 100B may be driven such that the position-input portion 140B supplies positional data in response to sensing of an object that is proximate to or touches the circular arc or a region outside the circular arc.

The user can support the data-processing device 100B by holding the circular arc or a region inside the circular arc in the position-input portion 140B in the unfolded state with one hand. The image used for operation and displayed outside the circular arc can be operated with the other hand. As a result, a human interface with high operability can be provided in the data-processing device 100B in the unfolded state. Furthermore, a novel data-processing device with high operability can be provided.

### Second Example

The program described here is different from the aforementioned one in including the following seven steps in which the area of the first figure and the area of the second figure are used instead of the length of the first line segment and the length of the second line segment (see FIG. 11). Different processes will be described in detail below, and the above description is referred to for the other similar processes.

In a first step, the area of the first figure is determined using the first positional data supplied by the first region 140B(I) (V1 in FIG. 11).

In a second step, the area of the second figure is determined using the second positional data supplied by the second region 140B(2) (V2 in FIG. 11).

In a third step, the area of the first figure and the area of the second figure are compared with a predetermined area. The program proceeds to a fourth step when only one of the area of the first figure and the area of the second figure is larger than the predetermined area. The program proceeds to the first step in other cases (V3 in FIG. 11). Note that it is preferable that the predetermined area be larger than or equal to 1 cm² and smaller than or equal to 8 cm², and it is particularly preferable that the predetermined area be larger than or equal to 3 cm² and smaller than or equal to 5 cm².

In the fourth step, the coordinates of the center of gravity of the figure whose area is larger than the predetermined area are determined (V4 in FIG. 11).

In a fifth step, folding data is acquired. The program proceeds to a sixth step when the folding data indicates a folded state. The program proceeds to a seventh step when the folding data indicates an unfolded state (V5 in FIG. 11).

In the sixth step, the first image data to be displayed on the display portion is generated in accordance with the coordinates of the center of gravity (V6 in FIG. 11).

In the seventh step, the second image data to be displayed on the display portion is generated in accordance with the coordinates of the center of gravity (V7 in FIG. 11).

The program is terminated in an eighth step (V8 in FIG. 11).

As mentioned above, the data-processing device 100B described here includes the flexible position-input portion 140B capable of sensing proximity or touch of an object and supplying the positional data L-INF; the sensor portion 150 including the folding sensor 151 that can determine whether the flexible position-input portion 140B is in a folded state or an unfolded state; and the arithmetic portion 111 (FIG. 3). The flexible position-input portion 140B can be bent to form the first region 140B(1), the second region 140B(2) facing the first region 140B(1) in the folded state, and the third region 140B(3) which is positioned between the first region 140B(1) and the second region 140B(2) and overlaps with the display portion 130. The arithmetic portion 111 can compare the first positional data L-INF(1) supplied by the first region 140B(1) with the second positional data L-INF(2) supplied by the second region 140B(2) and generate the image data VIDEO to be displayed on the display portion 130 in accordance with the comparison result and the folding data.

With this structure, whether or not a palm or a finger is proximate to or touches the first region 140B(1) or the second region 140B(2) can be determined, and the image data VIDEO including a first image positioned for easy operation in the folded state of the position-input portion 140B (e.g., the first image in which an image used for operation is positioned) or a second image positioned for easy operation in the unfolded state of the position-input portion 140B can be generated. As a result, a human interface with high operability can be provided. Furthermore, a novel data-processing device with high operability can be provided.

This embodiment can be combined as appropriate with any of other embodiments in this specification.

### Embodiment 5

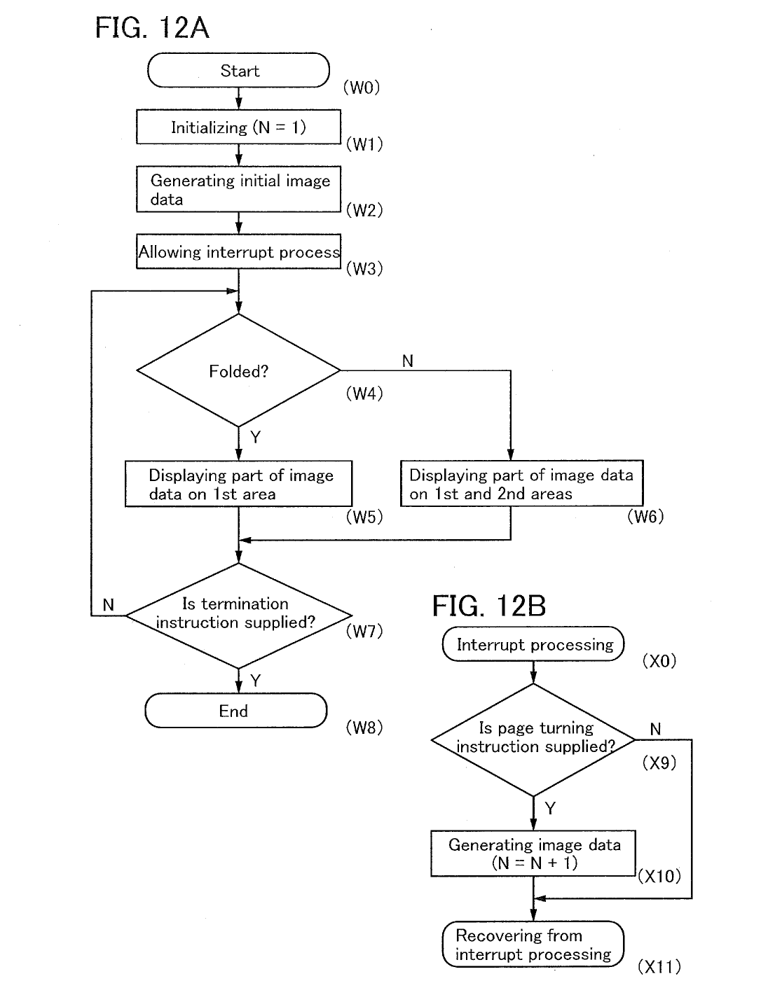

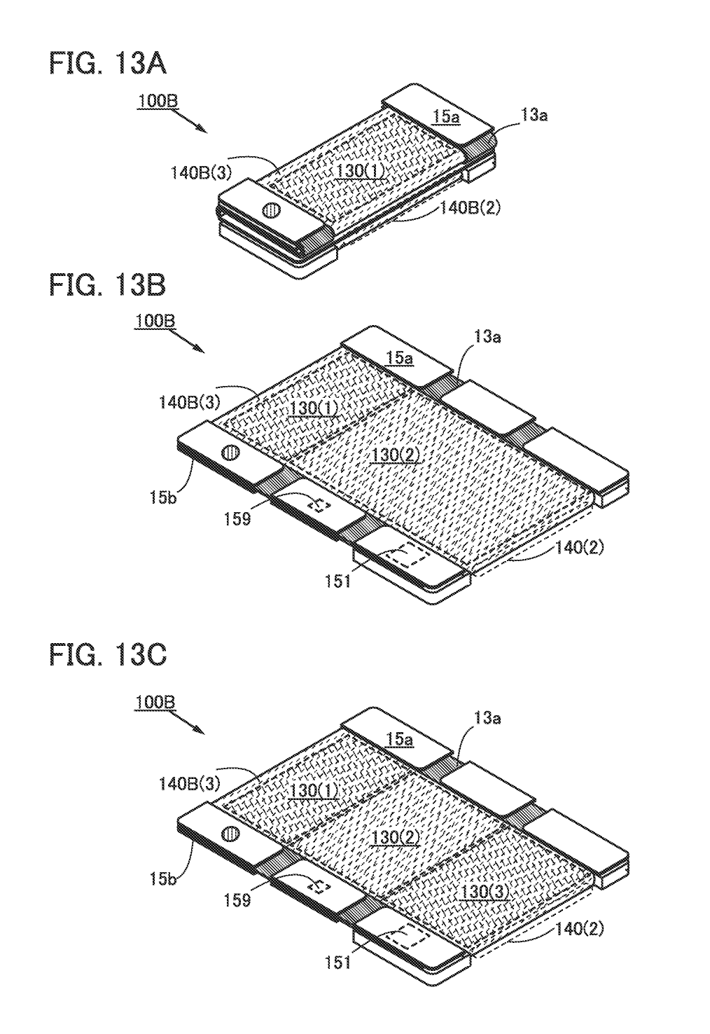

In this embodiment, a structure of the data-processing device of one embodiment of the present invention will be described with reference to FIGS. 12A and 12B and FIGS. 13A to 13C.

FIGS. 12A and 12B are flow charts showing the programs to be executed by the arithmetic portion 111 of the data-processing device 100B of one embodiment of the present invention.

FIGS. 13A to 13C are schematic views illustrating images displayed by the data-processing device 1001B of one embodiment of the present invention.

### <Structure Example of Data-Processing Device>

The data-processing device 100B described here is the data-processing device in Embodiment 2 in which the display portion 130 is flexible to be in an unfolded state and a folded state with the position-input portion 140B overlapping with the display portion 130 and includes a first area 130(1) exposed in the folded state and a second area 130(2) separated from the first area 130(1) at a fold (see FIG. 13B).

### <<Display Portion>>

The display portion 130 is flexible to be in an unfolded state and a folded state and overlaps with the third region 140(3) of the position-input portion 140B (see FIGS. 13A and 13B).

The display portion 130 can be regarded as having the first area 130(1) and the second area 130(2), and the first area 130(1) and the second area 130(2) are separated from each other at a fold and can be operated individually (see FIG. 13B).

The display portion 130 may be regarded as having the first area 130(1), the second area 130(2), and the third area 130(3) which are separated from one another at folds and can be operated individually, for example (FIG. 13C).

The entire display portion 130 may be the first area 130(1) without being divided by a fold (not illustrated).

Specific examples of a structure that can be employed in the display portion 130 are described in Embodiments 6 and 7.

The data-processing device includes the memory portion 112 that stores a program which is executed by the arithmetic portion Ill and includes a process including the following steps (see FIG. 3 and FIGS. 12A and 12B).

In a first step, initialization is performed (W1 in FIG. 12A).

In a second step, the initial image data VIDEO is generated (W2 in FIG. 12A).

In a third step, interrupt processing is allowed (W3 in FIG. 12A). Note that when the interrupt processing is allowed, the arithmetic portion 111 receives an instruction to execute the interrupt processing, stops the main processing, executes the interrupt processing, and stores the execution result in the memory portion. Then, the arithmetic portion 111 resumes the main processing on the basis of the execution result of the interrupt processing.

In a fourth step, folding data is acquired. The program proceeds to a fifth step when the folding data indicates a folded state. The program proceeds to a sixth step when the folding data indicates an unfolded state (W4 in FIG. 12A).

In the fifth step, at least part of the supplied image data VIDEO is displayed on the first area (W5 in FIG. 12A).

In the sixth step, part of the supplied image data VIDEO is displayed on the first area and another part of the supplied image data VIDEO is displayed on the second area or on the second and third areas (W6 in FIG. 12A).

In a seventh step, the program proceeds to an eighth step when a termination instruction is supplied in the interrupt processing and proceeds to the third step when the termination instruction is not supplied in the interrupt processing (W7 in FIG. 12A).

The program is terminated in the eighth step (W8 in FIG. 12A).

The interrupt processing includes the following steps.

In a ninth step, the program proceeds to a tenth step when a page turning instruction is supplied and proceeds to an eleventh step when the page turning instruction is not supplied (X9 in FIG. 12B).

In the tenth step, the image data VIDEO based on the page turning instruction is generated (X0 in FIG. 12B).

In the eleventh step, the program recovers from the interrupt processing (X11 in FIG. 12B).

### <<Example of Generated Image>>

The arithmetic unit 110 generates the image data VIDEO to be displayed on the display portion 130. Although an example in which the arithmetic unit 110 generates one image data VIDEO is described in this embodiment, the arithmetic unit 110 can also generate the image data VIDEO to be displayed on the second area 130(2) of the display portion 130 in addition to the image data VIDEO to be displayed on the first area 130(1).

For example, the arithmetic unit 110 can generate an image in only the first area 130(1) exposed in the folded state, giving a driving method favorable in the folded state (FIG. 13A).

On the other hand, the arithmetic unit 110 can generate an image by using the whole of the display portion 130 including the first area 130(1), the second area 130(2), and the third area 130(3) in the unfolded state. Such an image has high browsability (FIGS. 13B and 13C).

For example, an image used for operation may be positioned in the first area 130(1) in the folded state.

For example, an image used for operation may be positioned in the first area 130(1) and a display region (also called window) for application software may be positioned in the second area 130(2) or in the whole of the second area 130(2) and the third area 130(3) in the unfolded state.

Additionally, in accordance with a page turning instruction, an image positioned in the second area 130(2) may be moved to the first area 130(1) and a new image may be displayed in the second area 130(2).

When a page turning instruction is supplied to any of the first area 130(1), the second area 130(2), and the third area 130(3), a new image is provided thereto and an image displayed in another area is maintained. Note that the page turning instruction is an instruction for selecting and displaying one image data from a plurality of image data that are associated with page numbers. An example of such an instruction is one for selecting and displaying image data associated with the next larger page number than the page number of displaying image data. A gesture (e.g., tap, drag, swipe, or pinch-in) made by using a finger touching the position-input portion 140B as a pointer can be associated with the page turning instruction.

As mentioned above, the data-processing device 100B described here includes the display portion 130 that is flexible to be in an unfolded state and a folded state and that includes the first area 130(1) exposed in the folded state and the second area 130(2) separated from the first area 130(1) at a fold. Furthermore, the data-processing device includes the memory portion 112 that stores a program executed by the arithmetic portion 111 and including a step of displaying part of a generated image on the first area 130(1) or displaying another part of the generated image on the second area 130(2) in accordance with the sensing data SENS including folding data.

Therefore, in the folded state, part of an image can be displayed on the display portion 130 (the first area 130(1)) exposed in the folded state of the data-processing device 100B, for example. In the unfolded state, another part of the image that is continuous with or relevant to the part of the image can be displayed on the second area 130(2) of the display portion 130 that is continuous with the first area 130(1), for example. As a result, a human interface with high operability can be provided. Furthermore, a novel data-processing device with high operability can be provided.

This embodiment can be combined as appropriate with any of other embodiments in this specification.

### Embodiment 6

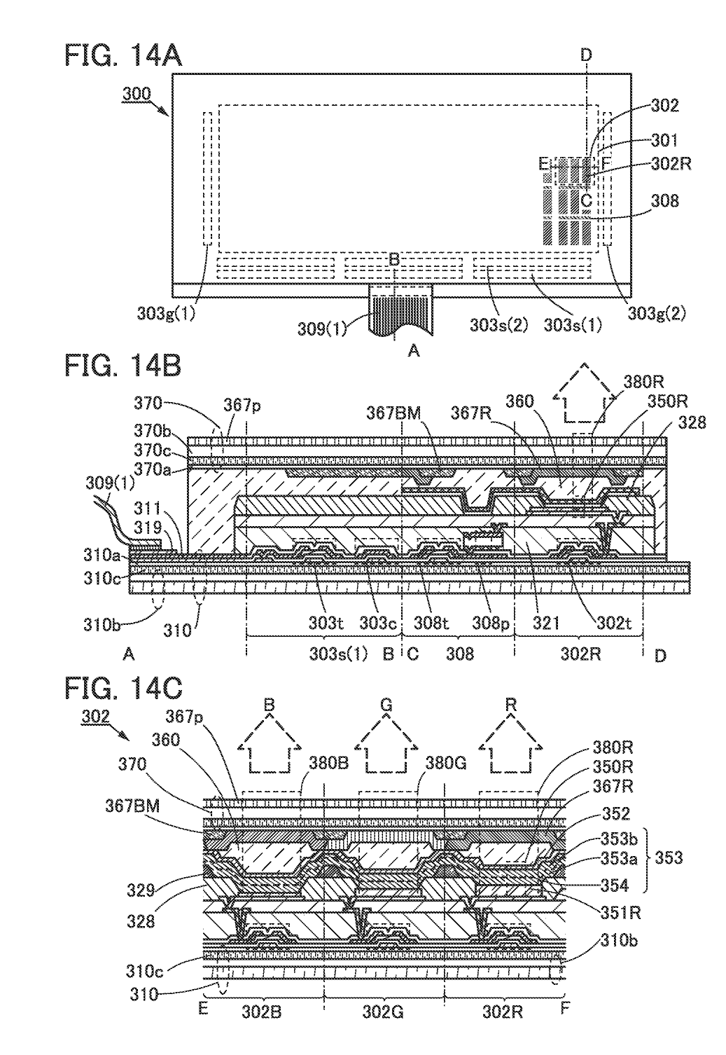

In this embodiment, the structure of a display panel that can be used for a position-input portion and a display device of the data-processing device of one embodiment of the present invention will be described with reference to FIGS. 14A to 14C. Note that the display panel described in this embodiment includes a touch sensor (a contact sensor device) that overlaps with a display portion; thus, the display panel can be called a touch panel (an input/output device).

FIG. 14A is a top view illustrating the structure of the input/output device.

FIG. 14B is a cross-sectional view taken along line A-B and line C-D in FIG. 14A.

FIG. 14C is a cross-sectional view taken along line E-F in FIG. 14A.

### <Top View>

An input/output unit 300 includes a display portion 301 (see FIG. 14A).

The display portion 301 includes a plurality of pixels 302 and a plurality of imaging pixels 308. The imaging pixels 308 can sense a touch of a finger or the like on the display portion 301.

Each of the pixels 302 includes a plurality of sub-pixels (e.g., a sub-pixel 302R). In the sub-pixels, light-emitting elements and pixel circuits that can supply electric power for driving the light-emitting elements are provided.

The pixel circuits are electrically connected to wirings through which selection signals and image signals are supplied.

The input/output unit 300 is provided with a scan line driver circuit 303g(1) that can supply selection signals to the pixels 302 and an image signal line driver circuit 303s(1) that can supply image signals to the pixels 302. Note that when the image signal line driver circuit 303s(1) is placed in a portion other than a bendable portion, malfunction can be inhibited.

The imaging pixels 308 include photoelectric conversion elements and imaging pixel circuits that drive the photoelectric conversion elements.

The imaging pixel circuits are electrically connected to wirings through which control signals and power supply potentials are supplied.

Examples of the control signals include a signal for selecting an imaging pixel circuit from which a recorded imaging signal is read, a signal for initializing an imaging pixel circuit, and a signal for determining the time for an imaging pixel circuit to sense light.

The input/output unit 300 is provided with an imaging pixel driver circuit 303g(2) that can supply control signals to the imaging pixels 308 and an imaging signal line driver circuit 303s(2) that reads out imaging signals. Note that when the imaging signal line driver circuit 303s(2) is placed in a portion other than a bendable portion, malfunction can be inhibited.

### <Cross-Sectional View>

The input/output unit 300 includes a substrate 310 and a counter substrate 370 opposite to the substrate 310 (see FIG. 14B).

The substrate 310 is a stacked body in which a substrate 310b having flexibility, a barrier film 310a that prevents unintentional diffusion of impurities to the light-emitting elements, and an adhesive layer 3100c that attaches the barrier film 310a to the substrate 310b are stacked.

The counter substrate 370 is a stacked body including a substrate 370b having flexibility, a barrier film 370a that prevents unintentional diffusion of impurities to the light-emitting elements, and an adhesive layer 370c that attaches the barrier film 370a to the substrate 370b (see FIG. 14B).

A sealant 360 attaches the counter substrate 370 to the substrate 310. The sealant 360 also serves as an optical adhesive layer. The pixel circuits and the light-emitting elements (e.g., a first light-emitting element 350R) and the imaging pixel circuits and photoelectric conversion elements (e.g., a photoelectric conversion element 308p) are provided between the substrate 310 and the counter substrate 370.

### <<Structure of Pixel>>

Each of the pixels 302 includes a sub-pixel 302R, a sub-pixel 302G, and a sub-pixel 302B (see FIG. 14C). The sub-pixel 302R includes a light-emitting module 380R, the sub-pixel 302G includes a light-emitting module 380G, and the sub-pixel 302B includes a light-emitting module 380B.

For example, the sub-pixel 302R includes the first light-emitting element 350R and the pixel circuit that can supply electric power to the first light-emitting element 350R and includes a transistor 302t (see FIG. 14B). The light-emitting module 380R includes the first light-emitting element 350R and an optical element (e.g., a first coloring layer 367R).

The transistor 302t includes a semiconductor layer. A variety of semiconductor films such as an amorphous silicon film, a low-temperature polysilicon film, a single crystal silicon film, and an oxide semiconductor film can be used for the semiconductor layer of the transistor 302t. The transistor 302t may include a back gate electrode, with which the threshold voltage of the transistor 302t can be controlled.

The first light-emitting element 350R includes a first lower electrode 351R, an upper electrode 352, and a layer 353 containing a light-emitting organic compound between the first lower electrode 351R and the upper electrode 352 (see FIG. 14C).

The layer 353 containing a light-emitting organic compound includes a light-emitting unit 353a, a light-emitting unit 353b, and an intermediate layer 354 between the light-emitting units 353a and 353b.

The first coloring layer 367R of the light-emitting module 380R is provided on the counter substrate 370. The coloring layer transmits light of a particular wavelength and is, for example, a layer that selectively transmits light of red, green, or blue color. A region that transmits light emitted from the light-emitting element as it is may be provided as well without providing the coloring layer.

The light-emitting module 380R, for example, includes the sealant 360 that is in contact with the first light-emitting element 350R and the first coloring layer 367R.

The first coloring layer 367R is positioned in a region overlapping with the first light-emitting element 350R. Accordingly, part of light emitted from the first light-emitting element 350R passes through the sealant 360 and the first coloring layer 367R and is emitted to the outside of the light-emitting module 380R as indicated by arrows in FIGS. 14B and 14C.

The input/output unit 300 includes a light-blocking layer 367BM on the counter substrate 370. The light-blocking layer 367BM is provided so as to surround the coloring layer (e.g., the first coloring layer 367R).

The input/output unit 300 includes an anti-reflective layer 367p positioned in a region overlapping with the display portion 301. As the anti-reflective layer 367p, a circular polarizing plate can be used, for example.

The input/output unit 300 includes an insulating film 321. The insulating film 321 covers the transistor 302t. Note that the insulating film 321 can be used as a layer for planarizing unevenness caused by the pixel circuits. An insulating film on which a layer that can prevent diffusion of impurities to the transistor 302t and the like is stacked can be used as the insulating film 321.

The light-emitting elements (e.g., the first light-emitting element 350R) are provided over the insulating film 321.

The input/output unit 300 includes, over the insulating film 321, a partition wall 328 that overlaps with an end portion of the first lower electrode 351R (see FIG. 14C). In addition, a spacer 329 that controls the distance between the substrate 310 and the counter substrate 370 is provided on the partition wall 328.

### <<Structure of Image Signal Line Driver Circuit>>

The image signal line driver circuit 303s(1) includes a transistor 303t and a capacitor 303c. The image signal line driver circuit 303s(1) can be formed in the same process and over the same substrate as those of the pixel circuits.

### <<Structure of Imaging Pixel>>

The imaging pixels 308 each include the photoelectric conversion element 308p and an imaging pixel circuit for sensing light received by the photoelectric conversion element 308p. The imaging pixel circuit includes a transistor 308t.

For example, a PIN photodiode can be used as the photoelectric conversion element 308p.

### <<Other Structures>>

The input/output unit 300 includes a wiring 311 through which a signal is supplied. The wiring 311 is provided with a terminal 319. Note that an FPC 309(1) through which a signal such as an image signal or a synchronization signal is supplied is electrically connected to the terminal 319. The FPC 309(1) is preferably placed in a portion other than a bendable portion of the input/output unit 300. Moreover, the FPC 309(1) is preferably placed at almost the center of one side of a region surrounding the display portion 301, especially a side which is folded (a longer side in FIG. 14A). Accordingly, the center of gravity of the external circuit can be made almost the same as that of the input/output unit 300. As a result, the data-processing device can be treated easily and mistakes such as dropping can be prevented.

Note that a printed wiring board (PWB) may be attached to the FPC 309(1).

Although the case where the light-emitting element is used as a display element is illustrated, one embodiment of the present invention is not limited thereto.

It is possible to use an electroluminescent (EL) element (e.g. an EL element including organic and inorganic materials, an organic EL element, an inorganic EL element, an LED), a light-emitting transistor (a transistor which emits light by current), an electron emitter, a liquid crystal element, an electronic ink display element, an electrophoretic element, an electrowetting element, a plasma display (PDP) element, a micro electro mechanical system (MEMS) display element (e.g., a grating light valve (GLV), a digital micromirror device (DMD), a digital micro shutter (DMS) element, an interferometric modulator display (IMOD) element, and the like), or a piezoelectric ceramic display, which has a display media whose contrast, luminance, reflectivity, transmittance, or the like is changed by electromagnetic action. Examples of display devices having EL elements include an EL display. Examples of a display device including an electron emitter include a field emission display (FED), an SED-type flat panel display (SED: surface-conduction electron-emitter display), and the like. Examples of display devices including liquid crystal elements include a liquid crystal display (e.g., a transmissive liquid crystal display, a transflective liquid crystal display, a reflective liquid crystal display, a direct-view liquid crystal display, or a projection liquid crystal display). Display devices having electronic ink or electrophoretic elements include electronic paper and the like.

This embodiment can be combined as appropriate with any of other embodiments in this specification.

### Embodiment 7

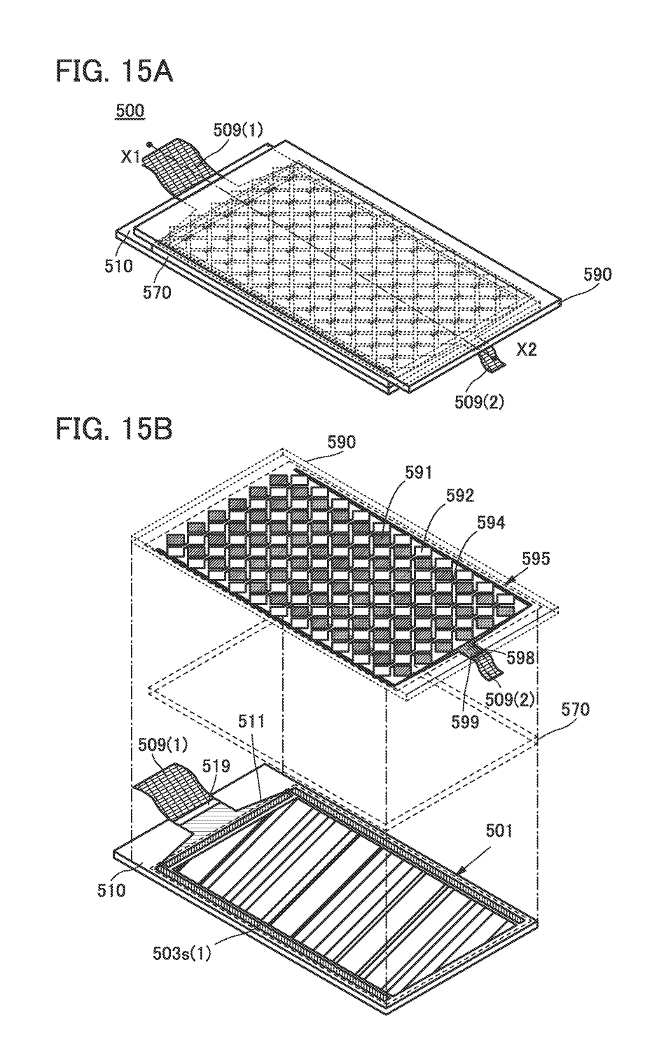

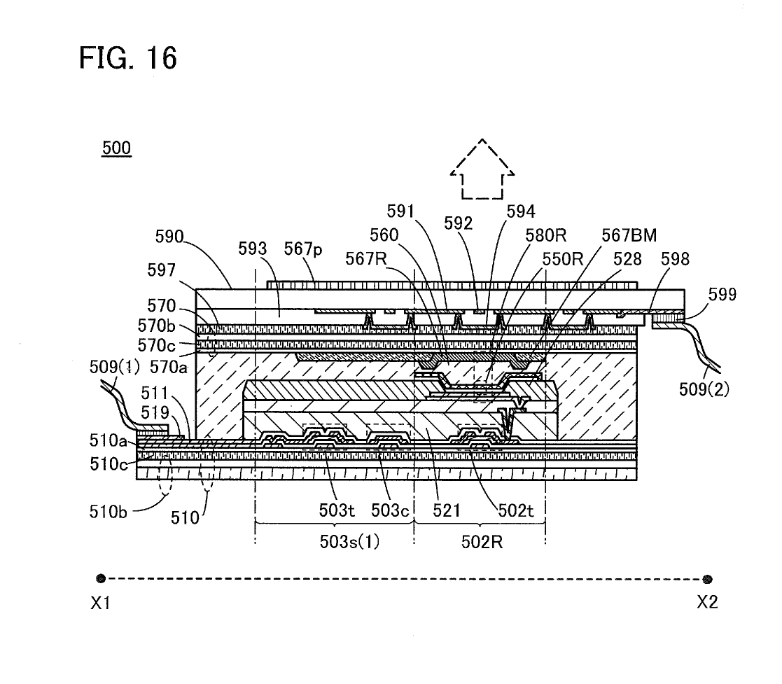

In this embodiment, the structure of a display panel that can be used for a position-input portion and a display device of the data-processing device of one embodiment of the present invention will be described with reference to FIGS. 15A and 15B and FIG. 16. Note that the display panel described in this embodiment includes a touch sensor (a contact sensor device) that overlaps with a display portion; thus, the display panel can be called a touch panel (an input/output device).

FIG. 15A is a schematic perspective view of a touch panel 500 described as an example in this embodiment. Note that FIGS. 15A and 15B illustrate only main components for simplicity. FIG. 15B is a developed view of the schematic perspective view of the touch panel 500.

FIG. 16 is a cross-sectional view of the touch panel 500 taken along line X1-X2 in FIG. 15A.

The touch panel 500 includes a display portion 501 and a touch sensor 595 (see FIG. 15B). The touch panel 500 includes a substrate 510, a substrate 570, and a substrate 590. Note that, in an example, the substrate 510, the substrate 570, and the substrate 590 each have flexibility.

As the substrates, a variety of flexible substrates can be used. As the substrate, a semiconductor substrate (e.g. a single crystal substrate or a silicon substrate), an SOI substrate, a glass substrate, a quartz substrate, a plastic substrate, a metal substrate, or the like can be used.

The display portion 501 includes the substrate 510, a plurality of pixels over the substrate 510, a plurality of wirings 511 through which signals are supplied to the pixels, and an image signal line driver circuit 503s(1). The plurality of wirings 511 are led to a peripheral portion of the substrate 510, and part of the plurality of wirings 511 form a terminal 519. The terminal 519 is electrically connected to an FPC 509(1). Note that a printed wiring board (PWB) may be attached to the FPC 509(1).

### <Touch Sensor>

The substrate 590 includes the touch sensor 595 and a plurality of wirings 598 electrically connected to the touch sensor 595. The plurality of wirings 598 are led to the periphery of the substrate 590, and part of the wirings 598 forms a terminal for electrical connection to an FPC 509(2). Note that the touch sensor 595 is provided on the rear side of the substrate 590 (between the substrates 590 and 570), and the electrodes, the wirings, and the like are indicated by solid lines for clarity in FIG. 15B.

As a touch sensor used as the touch sensor 595, a capacitive touch sensor is preferably used. Examples of the capacitive touch sensor are of a surface capacitive type, of a projected capacitive type, and the like. Examples of the projected capacitive type are of a self-capacitive type, a mutual capacitive type, and the like mainly in accordance with the difference in the driving method. The use of a mutual capacitive type is preferable because multiple points can be sensed simultaneously.

An example of using a projected capacitive touch sensor is described below with reference to FIG. 15B. Note that a variety of sensors other than the projected capacitive touch sensor can be used.

The touch sensor 595 includes electrodes 591 and electrodes 592. The electrodes 591 are electrically connected to any of the plurality of wirings 598, and the electrodes 592 are electrically connected to any of the other wirings 598.

The electrode 592 is in the form of a series of quadrangles arranged in one direction as illustrated in FIGS. 15A and 15B. Each of the electrodes 591 is in the form of a quadrangle. A wiring 594 electrically connects two electrodes 591 arranged in a direction intersecting with the direction in which the electrode 592 extends. The intersecting area of the electrode 592 and the wiring 594 is preferably as small as possible. Such a structure allows a reduction in the area of a region where the electrodes are not provided, reducing unevenness in transmittance. As a result, unevenness in luminance of light passing through the touch sensor 595 can be reduced. Note that the shapes of the electrode 591 and the electrode 592 are not limited thereto and can be any of a variety of shapes.

Note that a structure may be employed in which the plurality of electrodes 591 are arranged so that gaps between the electrodes 591 are reduced as much as possible, and the electrode 592 is spaced apart from the electrodes 591 with an insulating layer interposed therebetween to have regions not overlapping with the electrodes 591. In this case, it is preferable to provide, between two adjacent electrodes 592, a dummy electrode electrically insulated from these electrodes because the area of regions having different transmittances can be reduced.

The structure of the touch panel 500 is described with reference to FIG. 16.

The touch sensor 595 includes the substrate 590, the electrodes 591 and the electrodes 592 provided in a staggered arrangement on the substrate 590, an insulating layer 593 covering the electrodes 591 and the electrodes 592, and the wiring 594 that electrically connects the adjacent electrodes 591 to each other.

An adhesive layer 597 attaches the substrate 590 to the substrate 570 so that the touch sensor 595 overlaps with the display portion 501.

The electrodes 591 and the electrodes 592 are formed using a light-transmitting conductive material. As a light-transmitting conductive material, a conductive oxide such as indium oxide, indium tin oxide, indium zinc oxide, zinc oxide, or zinc oxide to which gallium is added can be used.

The electrodes 591 and the electrodes 592 may be formed by depositing a light-transmitting conductive material on the substrate 590 by a sputtering method and then removing an unnecessary portion by any of various patterning techniques such as photolithography.

Examples of a material for the insulating layer 593 are a resin such as an acrylic resin or an epoxy resin, a resin having a siloxane bond, and an inorganic insulating material such as silicon oxide, silicon oxynitride, or aluminum oxide.

Openings reaching the electrodes 591 are formed in the insulating layer 593, and the wiring 594 electrically connects the adjacent electrodes 591. The wiring 594 is preferably formed using a light-transmitting conductive material, in which case the aperture ratio of the touch panel can be increased. The wiring 594 is preferably formed using a material that has higher conductivity than the electrodes 591 and the electrodes 592.

One electrode 592 extends in one direction, and a plurality of electrodes 592 are provided in the form of stripes.

The wiring 594 intersects with the electrode 592.

Adjacent electrodes 591 are provided with one electrode 592 provided therebetween and are electrically connected by the wiring 594.

Note that the plurality of electrodes 591 are not necessarily arranged in the direction orthogonal to one electrode 592 and may be arranged to intersect with one electrode 592 at an angle of less than 90 degrees.

One wiring 598 is electrically connected to any of the electrodes 591 and 592. Part of the wiring 598 functions as a terminal. For the wiring 598, a metal material such as aluminum, gold, platinum, silver, nickel, titanium, tungsten, chromium, molybdenum, iron, cobalt, copper, or palladium or an alloy material containing any of these metal materials can be used.

Note that an insulating layer that covers the insulating layer 593 and the wiring 594 may be provided to protect the touch sensor 595.

A connection layer 599 electrically connects the wiring 598 to the FPC 509(2).

As the connection layer 599, any of various anisotropic conductive films (ACF), anisotropic conductive pastes (ACP), or the like can be used.

The adhesive layer 597 has a light-transmitting property. For example, a thermosetting resin or an ultraviolet curable resin can be used; specifically, a resin such as an acrylic resin, an urethane resin, an epoxy resin, or a resin having a siloxane bond can be used.

### <Display Portion>

The touch panel 500 includes a plurality of pixels arranged in a matrix. Each of the pixels includes a display element and a pixel circuit for driving the display element.

In this embodiment, an example of using a white-emissive organic electroluminescent element as a display element will be described; however, the display element is not limited to such an element.

As the display element, for example, other than organic electroluminescent elements, any of a variety of display elements such as display elements (electronic ink) that perform display by an electrophoretic method, an electronic liquid powder method, or the like; MEMS shutter display elements; optical interference type MEMS display elements; and liquid crystal elements can be used. Note that a structure suitable for display elements to be used can be selected from a variety of pixel circuit structures.

The substrate 510 is a stacked body in which a substrate 510b having flexibility, a barrier film 510a that prevents unintentional diffusion of impurities to the light-emitting elements, and an adhesive layer 510c that attaches the barrier film 510a to the substrate 510b are stacked.

The substrate 570 is a stacked body in which a substrate 570b having flexibility, a barrier film 570a that prevents unintentional diffusion of impurities to the light-emitting elements, and an adhesive layer 570c that attaches the barrier film 570a to the substrate 570b are stacked.

A sealant 560 attaches the substrate 570 to the substrate 510. The sealant 560, also serves as an optical adhesive layer. The pixel circuits and the light-emitting elements (e.g. a first light-emitting element 550R) are provided between the substrate 510 and the substrate 570.

### <<Structure of Pixel>>

A pixel includes a sub-pixel 502R, and the sub-pixel 502R includes a light-emitting module 580R.

The sub-pixel 502R includes the first light-emitting element 550R. The pixel circuit can supply electric power to the first light-emitting element 550R and includes a transistor 502t. The light-emitting module 580R includes the first light-emitting element 550R and an optical element (e.g., a first coloring layer 567R).

The first light-emitting element 550R includes a lower electrode, an upper electrode, and a layer containing a light-emitting organic compound between the lower electrode and the upper electrode.

The light-emitting module 580R includes the first coloring layer 567R on the substrate 570. The coloring layer transmits light of a particular wavelength and is, for example, a layer that selectively transmits light of red, green, or blue color. A region that transmits light emitted from the light-emitting element as it is may be provided as well without providing the coloring layer.

The light-emitting module 580R, for example, includes the sealant 560 that is in contact with the first light-emitting element 550R and the first coloring layer 567R.

The first coloring layer 567R is positioned in a region overlapping with the first light-emitting element 550R. Accordingly, part of light emitted from the first light-emitting element 550R passes through the sealant 560 and the first coloring layer 567R and is emitted to the outside of the light-emitting module 580R as indicated by an arrow in FIG. 16.

### <<Structure of Image Signal Line Driver Circuit>>

The image signal line driver circuit 503s(1) includes a transistor 503t and a capacitor 503c. Note that the image signal line driver circuit 503s(1) can be formed in the same process and over the same substrate as those of the pixel circuits.

### <<Other Structures>>

The display portion 501 includes a light-blocking layer 567BM on the substrate 570. The light-blocking layer 567BM is provided so as to surround the coloring layer (e.g., the first coloring layer 567R).

The display portion 501 includes an anti-reflective layer 567p positioned in a region overlapping with pixels. As the anti-reflective layer 567p, a circular polarizing plate can be used, for example.

The display portion 501 includes an insulating film 521. The insulating film 521 covers the transistor 502t. Note that the insulating film 521 can be used as a layer for planarizing unevenness caused by the pixel circuits. An insulating film on which a layer that can prevent diffusion of impurities to the transistor 502t and the like is stacked can be used as the insulating film 521.

The display portion 501 includes, over the insulating film 521, a partition wall 528 that overlaps with an end portion of the first lower electrode. In addition, a spacer that controls the distance between the substrate 510 and the substrate 570 is provided on the partition wall 528.

This embodiment can be combined as appropriate with any of other embodiments in this specification.

This application is based on Japanese Patent Application serial no. 2013-213378 filed with Japan Patent Office on Oct. 11, 2013, the entire contents of which are hereby incorporated by reference.

What is claimed is:

1. A driving method of a portable data-processing device, the driving method comprising:
sensing touch of a palm of a hand of a user by a first region located at a first side surface of the portable data-processing device when the portable data-processing device is held by the hand;
sensing touch of a finger of the hand other than a thumb by a second region located at a second side surface of the portable data-processing device when the portable data-processing device is held by the hand; and
displaying an image used for operating the portable data-processing device on a third region comprising a display portion so that the image is located in a movable range of the thumb of the user holding the portable data-processing device,
wherein the second side surface faces the first side surface with the display portion interposed therebetween.

2. The driving method according to claim 1,
wherein the first region and the second region are configured to display an image.

3. The driving method according to claim 1,
wherein the first region, the second region, and the third region each comprise a touch sensor.

4. The driving method according to claim 1,
wherein the third region is in contact with the first region and the second region.

5. A portable data-processing device comprising:
a display portion including continuous first to third regions each comprising a touch sensor, the third region being interposed between the first region and the second region,
wherein the first region faces the second region,
wherein the touch sensor in the first region is configured to sense touch of a palm of a hand of a user when the portable data-processing device is held by the hand,
wherein the touch sensor in the second region is configured to sense touch of a finger of the hand other than a thumb when the portable data-processing device is held by the hand, and
wherein the third region is configured to display an image used for operating the portable data-processing device so that the image is located in a movable range of the thumb of the user holding the portable data-processing device.

6. The portable data-processing device according to claim 5,
wherein the display portion is flexible.

7. The portable data-processing device according to claim 5,
wherein the touch sensor is flexible.

8. The portable data-processing device according to claim 5,
wherein the touch sensor is a capacitive touch sensor.

9. A portable data-processing device comprising:
a display portion comprising continuous first to third regions, the third region being interposed between the first region and the second region,
wherein the first region faces the second region,
wherein the first to third regions each comprise a pixel and an imaging pixel,
wherein each of the pixels in the first to third regions comprises an element including a display media,
wherein each of the imaging pixels in the first to third regions comprises a photoelectric conversion element,
wherein the imaging pixel in the first region is configured to sense touch of a palm of a hand of a user when the portable data-processing device is held by the hand,
wherein the imaging pixel in the second region is configured to sense touch of a finger of the hand other than a thumb when the portable data-processing device is held by the hand, and
wherein the third region is configured to display an image used for operating the portable data-processing device so that the image is located in a movable range of the thumb of the user holding the portable data-processing device.

10. The portable data-processing device according to claim 9,
wherein the display portion is flexible.
